(19) United States
(12) Patent Application Publication
(10) Pub. No.: US 2025/0100688 A1
(43) Pub. Date: Mar. 27, 2025

(54) SEATING ASSEMBLY FOR AN AIRCRAFT

(71) Applicant: Cirrus Design Corporation d/b/a Cirrus Aircraft, Duluth, MN (US)

(72) Inventors: Zachary Woodward, Duluth, MN (US); Jim Schaff, Duluth, MN (US); David Artim, Duluth, MN (US); Peter Larson, Duluth, MN (US)

(73) Assignee: Cirrus Design Corporation d/b/a Cirrus Aircraft, Duluth, MN (US)

(21) Appl. No.: 18/897,648

(22) Filed: Sep. 26, 2024

Related U.S. Application Data
(60) Provisional application No. 63/585,500, filed on Sep. 26, 2023.

(51) Int. Cl. B64D 11/06

(52) U.S. Cl. CPC B64D 11/0619

(57) ABSTRACT

A seat assembly is provided including a base assembly, a seat pan supported by the base assembly, and a plurality of loading members positioned below the seat pan. The seat pan includes a first seat portion, a second seat portion, and a weakened portion. The first seat portion is supported by a first loading member of the plurality of loading members and the second seat portion is supported by a second loading member of the plurality of loading members. Further, the weakened portion extends longitudinally along the seat pan, and the weakened portion is positioned intermediate the first portion and the second portion.

### CROSS-REFERENCE TO RELATED APPLICATIONS

The present application claims priority to U.S. Provisional Patent Application Ser. No. 63/585,500, filed Sep. 26, 2023, attorney docket no. 475560.000066 and entitled “SEATING ASSEMBLY FOR AN AIRCRAFT,” the complete disclosure of which is expressly incorporated by reference herein.

### FIELD OF THE DISCLOSURE

The present disclosure relates to a seating assembly for an aircraft.

### BACKGROUND OF THE DISCLOSURE

The safety of the occupants of an aircraft is of the utmost importance. Aircraft manufacturers are constantly adding safety improvements to their aircrafts. One of the improvements includes reducing forces felt by occupants while seated on a seat in the aircraft. In a hard landing, parachute landing, or crash scenario, substantial impact forces may be imposed on occupants by the seating. Seating designs for reducing such forces are beneficial for promoting aircraft occupant safety.

### SUMMARY OF THE DISCLOSURE

In an embodiment of the present disclosure, a seat assembly is provided comprising a base assembly, a seat pan supported by the base assembly, and a plurality of loading members positioned below the seat pan. The seat pan comprises a first seat portion supported by a first loading member of the plurality of loading members, a second seat portion supported by a second loading member of the plurality of loading members, and a weakened portion extending longitudinally along the seat pan. Further, the weakened portion is positioned intermediate the first portion and the second portion.

In yet another embodiment of the present disclosure, a seat assembly is provided comprising a base assembly, a seat pan supported by the base assembly, and a plurality of loading members positioned below the seta pan. The seat pan comprises a first portion movable about a laterally extending axis and a second portion coupled to, and laterally offset from, the first portion. The second portion is movable about the laterally extending axis semi-independent of the first portion. Further, the seat pan comprises a first loading member of the plurality of loading members supporting the first portion and a second loading member of the plurality of loading members supporting the second portion.

In yet another embodiment of the present disclosure, a method of manufacturing a seat assembly is provided. The method comprises a seat pan, a first loading member, and a second loading member. The method comprises applying a first weakened portion into the seat pan, the first weakened portion separated the seat pan into a first seat portion and a second portion, positioning a first loading member vertically below the first portion to support the first portion, and positioning a second loading member vertically below the second portion to support the second portion semi-independently of the first portion.

### BRIEF DESCRIPTION OF THE DRAWINGS

FIG. 1 is a view of an aircraft, according to some embodiments;

FIG. 2 is a rear perspective view of a seat assembly for an aircraft, according to some embodiments;

FIG. 3 is a front perspective view of the seat assembly of FIG. 2 showing a seat back, according to some embodiments;

FIG. 4 is a side view of the seat assembly of FIG. 2 showing a seat back, according to some embodiments;

FIG. 5 is a rear view of the seat assembly of FIG. 2, according to some embodiments;

FIG. 6 is a front view of the seat assembly of FIG. 2, according to some embodiments;

FIG. 7 is a bottom view of the seat assembly of FIG. 2, according to some embodiments;

FIG. 8 is a rear perspective view of a seat pan of the seat assembly of FIG. 2, according to some embodiments;

FIG. 9 is a bottom perspective view of the seat pan of FIG. 8, according to some embodiments;

FIG. 10 is a top view of the seat pan of FIG. 8, according to some embodiments;

FIG. 11 is a section view of the seat pan of FIG. 8 taken along line 11-11 of FIG. 8, according to some embodiments;

FIG. 12 is a representative view of a layer assembly of a seat pan, according to some embodiments;

FIG. 13 is a side perspective view of the seat assembly of FIG. 2, according to some embodiments;

FIG. 14 is a section view of the seat assembly of FIG. 13 taken along line 14-14 of FIG. 13, according to some embodiments;

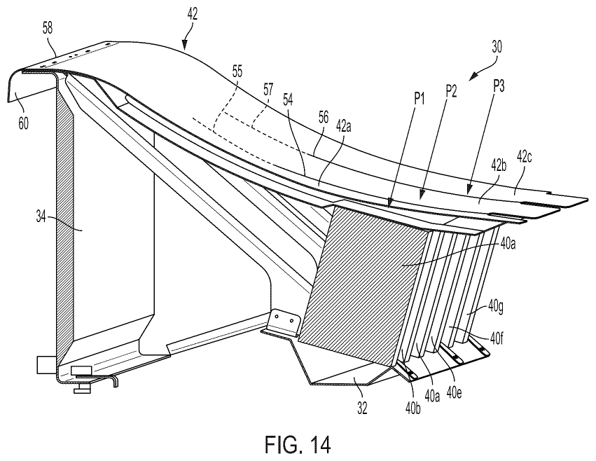

FIG. 15 is a bottom view of the seat pan of FIG. 8 with a plurality of loading members, according to some embodiments;

FIG. 16A is a diagrammatic rear view of the seat assembly of FIG. 2 with a lateral outward portion of the seat pan deflected, according to some embodiments;

FIG. 16B is a diagrammatic rear view of the seat assembly of FIG. 2 with a middle portion of the seat pan deflected, according to some embodiments;

FIG. 16C is a diagrammatic rear view of the seat assembly of FIG. 2 with each of the portions of the seat pan deflected, according to some embodiments;

FIG. 16D is a diagrammatic rear view of the seat assembly of FIG. 2 with an outward portion and a middle portion of the seat pan deflected, according to some embodiments;

FIG. 16E is a diagrammatic rear view of the seat assembly of FIG. 2 with a middle portion of the seat pan deflected, according to some embodiments;

FIG. 17A is a diagrammatic rear view of the seat assembly of FIG. 2 with three passengers exerting a downward force, according to some embodiments;

FIG. 17B is a diagrammatic rear view of the seat assembly of FIG. 2 with two passengers exerting a downward force, according to some embodiments;

FIG. 18 is a diagrammatic rear view of a seat assembly with three loading members, according to some embodiments;

FIG. 19 is a bottom perspective view of the seat assembly of FIG. 18, according to some embodiments;

FIG. 20A is a diagrammatic rear view of a seat assembly with an alternate seat pan with three passengers in a first seating configuration, according to some embodiments;

FIG. 20B is a diagrammatic rear view of the seat assembly of FIG. 20A with three passengers in a second seating configuration, according to some embodiments;

FIG. 21A is a top view of the alternate seat pan of FIG. 20A with three passengers in the first seating configuration, according to some embodiments;

FIG. 21B is a top view of the alternate seat pan of FIG. 20A with three passengers in the second seating configuration, according to some embodiments;

FIG. 22 is a front left perspective view of a bench assembly, according to some embodiments;

FIG. 23 is a rear left perspective view of the bench assembly of FIG. 22;

FIG. 24 is a rear view of the bench assembly of FIG. 22;

FIG. 25 is a left view of the bench assembly of FIG. 22;

FIG. 26 is a perspective view of a seat pan of the bench assembly of FIG. 22;

FIG. 27 is a left view of the seat pan of FIG. 26;

FIG. 28 is a bottom perspective of the seat pan of FIG. 26;

FIG. 29 is a left view of the seat pan of FIG. 26, taken along line 29-29 of FIG. 26;

FIG. 30 is a left view of the seat pan of FIG. 26, taken along line 30-30 of FIG. 26;

FIG. 31A is a left view representation of the bench assembly of FIG. 26 with the seat pan shown in an undeflected condition; and

FIG. 31B is a left view representation of the bench assembly of FIG. 26 with the seat pan shown in a deflected condition.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

Various embodiments described in this patent specification relate to bench-style seating having a plurality of seat pan portions suitable for one or more passengers. The seating includes one or more weakened portions between the seat pan portions which provide preferential failure regions for the seat pans to move and deform relative to one another under increased forces associated with vertical impact events (e.g., hard or emergency parachute landings). These preferential failure regions facilitate independent movement and engagement of the seat pan portions with impact absorbing loading members associated with the seating, which in turn permits a more tailored and efficient load response to such downward forces. These and other additional or alternative advantages and features are apparent from this patent specification.

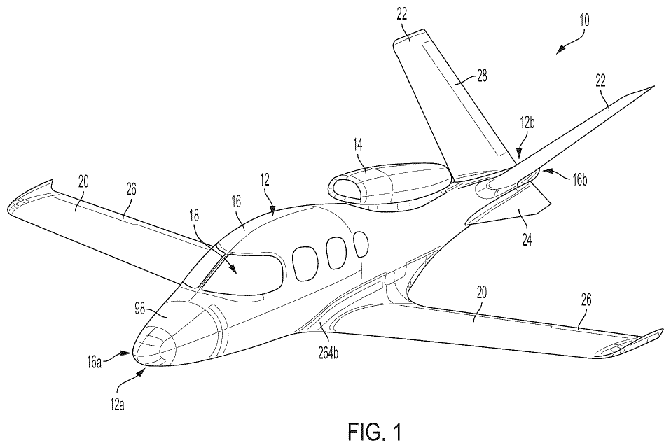

FIG. 1 shows an example of an aircraft 10 in which seating of the type described above may be provided, although a variety of aircraft types and designs are contemplated. As shown in FIG. 1, aircraft 10 is an airplane including a body 12 and a propulsion unit 14 operably coupled to body 12 and configured to propel body 12. Propulsion unit 14 may be a turbofan jet engine, for example. In some embodiments, propulsion unit 14 may be a piston driven propeller engine. Body 12 is generally a fuselage 16 extending longitudinally and defining a cabin 18. A pair of wings 20 extend laterally outwardly from fuselage 16. As shown, each wing 20 includes a roll control surface 26 actuatable by a roll control actuator controllable by an operator of aircraft 10. In some embodiments, each roll control surface 26 is an aileron. A pair of upper stabilizers 22 extend outwardly from fuselage 16 (e.g., a V-tail or butterfly tail stabilizer pattern), and a pair of lower stabilizers 24 extend outwardly from the fuselage 16 vertically below upper stabilizers 22. Each upper stabilizer 22 includes a pitch control surface 28 actuatable by a pitch control actuator controllable by an operator of aircraft 10. In some embodiments, pitch control surface 28 is a combination surface combining the conventional functions of both an elevator and a rudder (i.e., a ruddervator). Aircraft 10 includes a nose 12a at a longitudinally forward extent 16a of fuselage 16 and a tail 12b at a longitudinally rearward extent 16b of fuselage 16.

In some embodiments, aircraft 10 is a civilian airplane for business or private use. Aircraft 10 may be a multi-seat light aircraft approved for single-pilot operation. In some embodiments, as illustrated, aircraft 10 is a multi-seat personal jet with a pilot plus passenger capacity up to seven. In alternative terms, aircraft 10 may also referred to as a very light jet, entry-level jet, or microjet.

It is permissible according to some aspects of the present invention, however, for the aircraft to be an entirely different type of airplane or to be of an alternative aircraft type entirely. For instance, the aircraft might be manned or unmanned (e.g., a drone or unmanned aerial vehicle). The aircraft might be a rotorcraft such as a helicopter, a fixed wing aircraft, or an ornithopter. Onboard power might be provided by one or more jet engines (e.g., turbojets, turbofans, pulse jets, ram jets, and/or hybrids thereof), propellers, and/or rockets. The aircraft might also be devoid of onboard propulsion power (e.g., a glider or satellite). The aircraft might be a personal aircraft (e.g., a recreational ultralight), a small business aircraft (e.g., a crop duster), a large commercial aircraft (e.g., an international passenger jet), or a military aircraft (e.g., a fighter jet). As will be apparent to those of ordinary skill in the art, additional aircraft not listed above may also fall within the scope of the present invention.

As shown in FIG. 1, aircraft 10 may include a parachute system configured to deploy a parachute and allow aircraft 10 to descend safely to the ground. That is, the parachute system may deploy and aircraft 10 may descend and approach the ground in a generally vertical direction (i.e., approximately perpendicular to the ground). Additional details regarding a parachute system may be found in U.S. Pat. No. 8,056,861, issued on Nov. 15, 2011, the entire disclosure of which is expressly incorporated by reference herein.

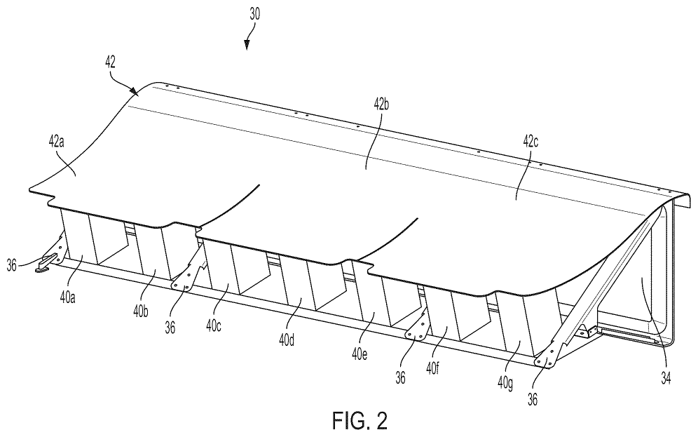

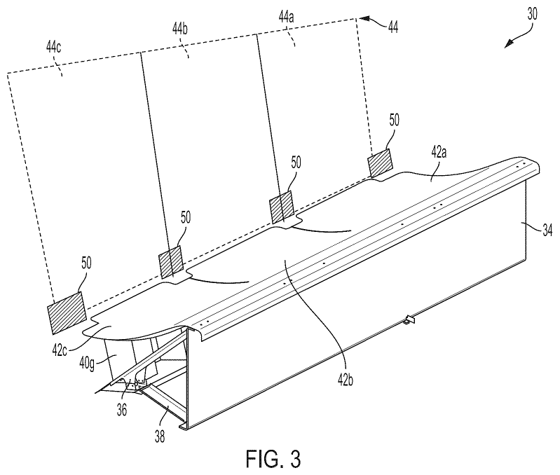

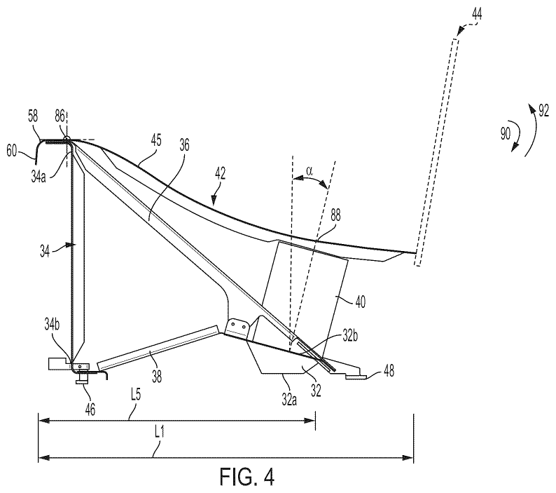

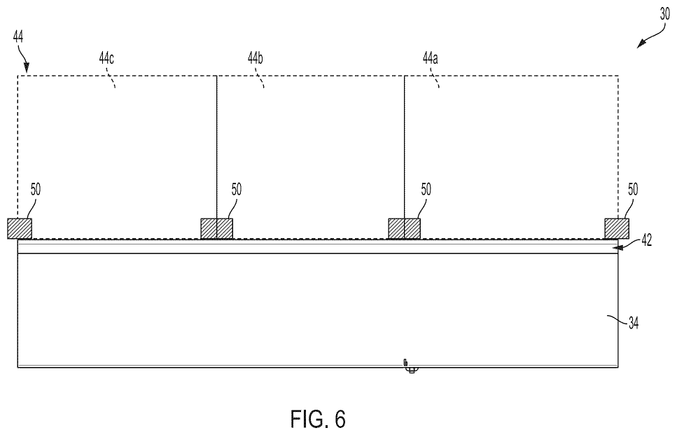

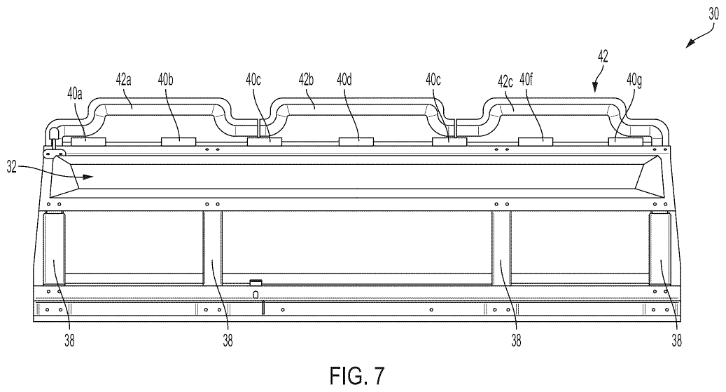

As shown in FIGS. 2-7, a bench 30 is configured to be positioned within cabin 18. Bench 30 is configured to support one or more passengers of aircraft 10. FIG. 2 is a rear-oriented, isometric view of the bench 30 with the backrest, or seat back portion removed from the view for ease of visualization. Bench 30 includes a base member 32, a forward wall 34, and a plurality of first frame members 36 coupled between base member 32 and an upper portion 34a of forward wall 34. FIG. 3 is a front-oriented, isometric view of the bench 30. As shown, the bench also includes a plurality of second frame members 38 coupled between base member 32 and a lower portion 34b of forward wall 34. FIG. 4 is an end view of the bench 30. As shown, each of forward wall 34, first frame members 36, and second frame members 38 create a triangular structure to increase the structural rigidity of bench 30. In embodiments, a truss is created between forward wall 34, first frame member 36 and the floor of cabin 18. That is, forward wall 34 is generally in compression while first frame member 36 is generally in tension, and the floor of cabin 18 is coupled between forward wall 34 and first frame member 36. Bench 30 generally includes truss members (e.g., forward wall 34, first frame member 36, floor of cabin 18) which allows a lightweight construction. In embodiments, other shapes may be used to support bench 30 (e.g., four members, five members, six members, or more members). Base member 32 includes a lower surface 32a configured to couple to a portion of cabin 18 (e.g., a frame member) and an upper surface 32b. In some embodiments, base member 32 is a polygonal structure and lower surface 32a is a flat surface, and upper surface 32b is angled relative to lower surface 32a at an angle α. In embodiments, angle α is less than 30 degrees. In embodiments, angle α is less than 20 degrees. In embodiments, angle α is greater than 10 degrees. In embodiments, angle α is approximately 15 degrees.

Forward wall 34 generally defines a front height H1 of bench 30. A plurality of loading members 40 extend upwardly from base member 32, and a seat pan, or seat member 42 is supported by front wall 34 and each of loading members 40. In some embodiments, a seat back 44 (FIGS. 3, 4, and 6) extends upwardly from a rear extent of seat member 42 to provide back support to one or more of the passengers supported by bench 30.

As shown in FIG. 4, bench 30 is configured to couple to a floor (not shown) of cabin 18 by a plurality of couplers including a plurality of front couplers 46 and a plurality of rear couplers 48. In some embodiments, front couplers 46 are coupled between each of forward wall 34, second frame members 38, and the floor of cabin 18. In some embodiments, rear couplers 48 are coupled between base member 32, first frame members 36, and the floor of cabin 18. The couplers may be any of a variety of fasteners, including threaded fasteners such as screws or bolts.

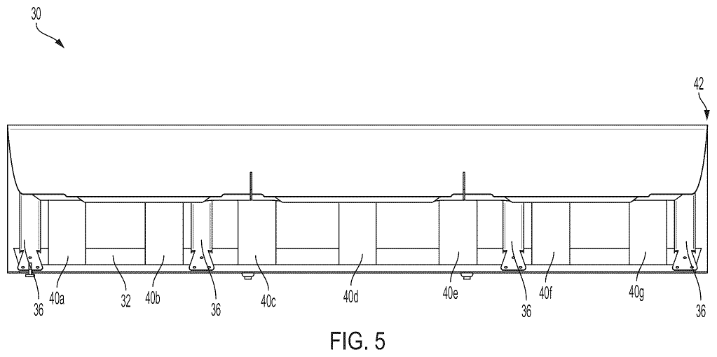

As shown in FIG. 5, bench 30 includes a plurality of loading members 40, including a first loading member 40a, a second loading member 40b, a third loading member 40c, a fourth loading member 40d, a fifth loading member 40e, a sixth loading member 40f, and a seventh loading member 40g. The plurality of loading members 40, also described as crush cores 40, are compressible members configured to crush, or compress, under predetermined loads. Loading members 40 are comprised of a plurality of sheets, or honeycomb structure of a primary material configured to withstand predetermined forces (e.g., normal forces). In some embodiments, the sheets of material are made of aluminum, steel, polyester, carbon fiber, plastic, or another material suitable for withstanding normal forces and absorbing energy. In some embodiments, a secondary material (e.g., a foam, plastic, or other material) is configured to be placed between the plurality of sheets, or honeycomb structure of the primary material. The primary material and secondary material may be different densities. Loading members 40 may compress in a non-uniform manner depending upon the location and degree of force applied to the loading members 40. That is, loading members 40 may be configured to compress according to the application of force applied to the loading member. In some embodiments, loading member 40 includes a first portion and a second portion that are configured to compress independently dependent upon the location and degree of force applied thereto. In other words, the first portion may receive a normal force and compress while the second portion does not receive a normal force and does not compress or otherwise maintains its shape. In some embodiments, loading member 40 comprises a plurality of portions, and any portion may deflect independent of the remaining plurality of portions. That is, loading member 40 may be zonally responsive to forces applied to different portions of loading member 40. In some embodiments, loading members 40 are constructed to minimize lateral deflection. In embodiments, loading members 40 may be narrower or wider than shown (e.g., any width) such that more or less loading members need to be used, respectively, or the spacing of the loading members 40 may be altered (e.g., be any spacing).

Loading members 40 are configured to receive and dissipate a downward normal force, a lateral shear force, and/or a longitudinal shear forces. In some embodiments, loading members 40 are constructed to absorb and decelerate a received force. That is, loading members 40 may receive a high impulse force (e.g., from a passenger) and absorb the impulse force and decelerate the force to a stand-still. In some embodiments, loading members 40 progressively decelerate the forces as loading member 40 compresses or deflects a greater amount.

Loading members 40a-40g may be comprised of different materials, different combinations of materials, or otherwise constructed differently from one another to accommodate various strengths. For example, when a force is applied to each of loading member 40c and loading member 40d, and loading member 40c may be configured to crush, or deform, a different amount than loading member 40d is configured to crush or deform.

As shown in FIG. 3, bench 30 is configured with a plurality of seat restraints, or seat belts 50. Seat restraints 50 may be lap belts, harnesses, shoulder harnesses, multi-point harnesses, or other type of restraints configured to retain passengers to bench 30. Seat restraints 50 may include an anchor and a coupler (i.e., buckle) such that a seat belt (not shown) extends over a lap of a passenger and couples between the anchor and coupler.

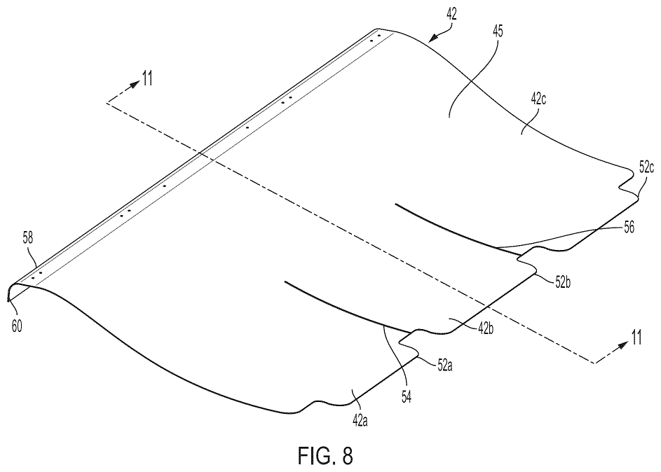

As shown in one or more of FIGS. 8-12, seat member 42 includes a first seat portion 42a, a second seat portion 42b, and a third seat portion 42c. In some embodiments, first seat portion 42a is separated from second seat portion 42b by a first portion or first weakened portion 54 and second seat portion 42b is separated from third seat portion 42c by a second portion or second weakened portion 56. In the present embodiment, each of first weakened portion 54 and second weakened portion 56 is a weakened region, or weakened portion relative to first seat portion 42a, second seat portion 42b, and third seat portion 42c. In some embodiments, first weakened portion 54 and second weakened portion 56 are defined to be thinner than first seat portion 42a, second seat portion 42b, third seat portion 42c such that they are weakened relative the first, second, and third seat portions 42a, 42b, 42c. In some embodiments, each of first weakened portion 54 and second weakened portion 56 include scores or score marks, fracture lines, or through-cuts, or a combination of a score mark, fracture line, and a through-cut. Seat member 42 also includes a lip 60 positioned at a generally forward extent 58 of seat member 42.

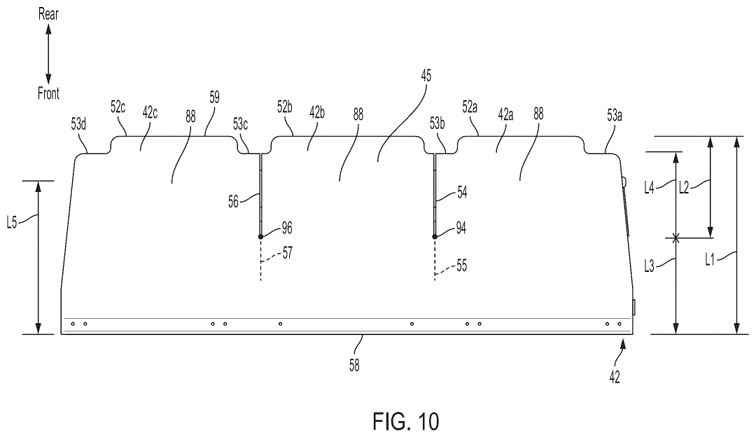

As best seen in FIG. 4, seat member 42 couples to front wall 34 adjacent forward extent 58 of seat member 42 and lip 60 extends downwardly to cover at least a portion of the upper portion 34a of front wall 34. As shown in FIGS. 8 and 10, seat member 42 also includes a plurality of tabs 52. As shown, first seat portion 42a has a rear tab 52a, second seat portion 42b has a rear tab 52b, and third seat portion 42c has a rear tab 52c. In some embodiments, rear tabs 52a, 52b, 52c are separated by a plurality of recesses, or notches 53 which receive at least a portion of seat restraints 50. Each of notches 53 are positioned at a rearward extent 59 of seat member 42. In some embodiments, the plurality of notches 53 includes a first notch 53a, a second notch 53b, a third notch 53c, and a fourth notch 53d. In some embodiments, seat member 42 has a length L1 defined between the forward extent 58 and rearward extent 59. In some embodiments, seat member 42 is generally curved and has an upper surface 45 (FIG. 4) that is generally concave. That is, seat member 42 is ergonomically contoured to improve seating comfort and generally conform to a person sitting on seat member 42 along upper surface 45. In some embodiments, a first seat restraint 50 is at least partially laterally aligned with first weakened portion 54 and a second seat restraint 50 is at least partially laterally aligned with second weakened portion 56. In some embodiments, a first component (e.g., anchor) of the first seat restraint 50 is at least partially laterally aligned with first weakened portion 54, and a second component (e.g., coupler or buckle) of the first seat restraint 50 is at least partially laterally aligned with second weakened portion 56.

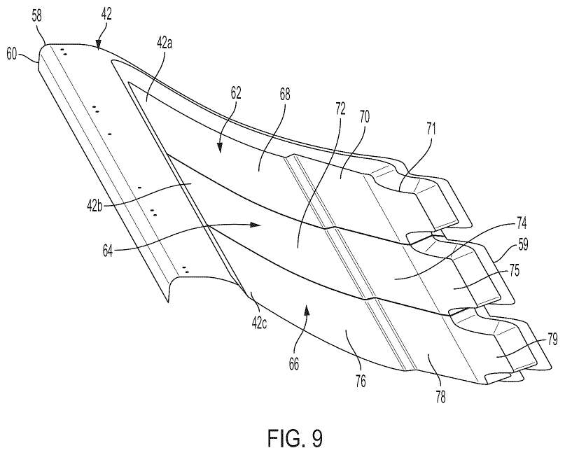

FIG. 9 is a bottom-oriented, isometric view of the seat member 42. As shown, first seat portion 42a includes a first body portion 62 that extends generally downwardly, second seat portion 42b includes a second body portion 64 that extends generally downwardly, and third seat portion 42c includes a third body portion 66 that extends generally downwardly. In some embodiments, first body portion 62 includes a forward body portion 68, a middle body portion 70, and a rear body portion 71, second body portion 64 includes a forward body portion 72, a middle body portion 74, and a rear body portion 75, and third body portion 66 includes a forward body portion 76, a middle body portion 78, and a rear body portion 79. Each of first body portion 62, second body portion 64, and third body portion 66 are configured to increase the rigidity of first seat portion 42a, second seat portion 42b, and third seat portion 42c respectively.

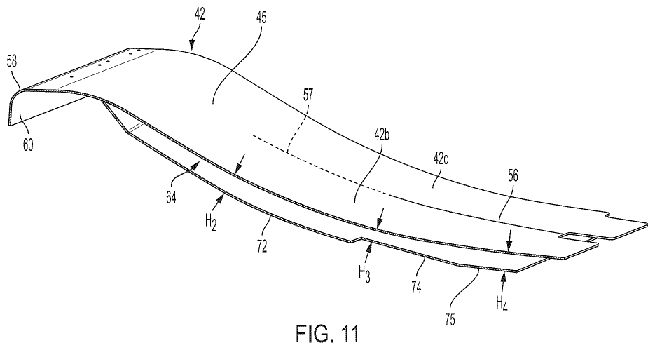

FIG. 11 is a side-oriented isometric view of the seat member 42. As shown, front body portion 72 of second body portion 64 has a height H2, or thickness H2 that is generally consistent along the length of front body portion 72. As shown, front body portion 72 is generally curved, or curvilinear to match, or substantially follow the contour of a top surface of seat member 42. Rear body portion 75 includes a height, or thickness H4 that is generally consistent along the length of rear body portion 75. In some embodiments, rear body portion 75 is generally curved, or curvilinear to match, or substantially follow the contour of a top surface of seat member 42. In some embodiments, height H4 is equal to, or substantially equal to, height H2. Middle body portion 74 has a variable thickness that includes a minimum height, or thickness H3. In some embodiments, middle body portion 74 has a variable thickness with the minimum height H3 at its forwardmost portion and a height equal to H4 at its rearwardmost portion. In some embodiments, middle body portion 74 is a generally flat surface and, in a neutral, or undeflected position, middle body portion 74 is generally parallel to upper surface 32b of base member 32. As shown, one of loading members 40 may be configured to be received between upper surface 32b of base member 32 and middle body portion 74.

In some embodiments, each of first body portion 62, second body portion 64, and third body portion 66 are constructed the same or substantially similar to one another. That is, forward body portions 68, 76 are substantially the same as, or similar to, forward body portion 72. Middle body portions 70, 78 are substantially the same as, or similar to, middle body portion 74. Rear body portions 71, 79 are substantially the same as, or similar to, rear body portion 75. Further, each of loading members 40a-40g are configured to extend between upper surface 32b of base member 32 and each of middle body portions 70, 74, 78.

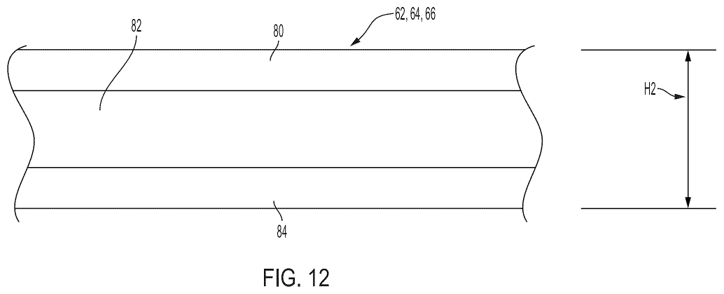

FIG. 12 is a sectional representation of each of the body portions 62, 64, 66. As shown in FIG. 12, each of body portions 62, 64, 66 may be a composite of one or more sheets of materials. In some embodiments, body portions 62, 64, 66 include a tri-sheet structure including a first layer, or top layer 80, a second layer, or middle layer 82, and a third layer, or bottom layer 84. Middle layer 82 is intermediate each of top layer 80 and bottom layer 84. In some embodiments, each of layers 80, 82, 84 may be made of the same, or different materials, which may affect the overall structural properties of seat member 42. In some embodiments, top layer 80 and bottom layer 84 are the same material, or a first material and middle layer 82 is a different material, or second material. In some embodiments, top layer 80 and bottom layer 84 are comprised of a fiberglass composite and middle layer 82 is made of a polyvinyl chloride foam (PVC) composite. In some embodiments, each of body portions 62, 64, 66 may be made of a single sheet of material, two sheets of material, three sheets of material, four sheets of material, five sheets of material, or more sheets of material. In some embodiments, various additional materials may be used in place of, or with, the fiberglass composite and PVC composite, such as carbon-fiber, polyethylene, polypropylene, aluminum, aramid fiber or any other material or polymer. Each layer 80, 82, 84 is configured separately such that the body portions 62, 64, 66, have desired structural characteristics (e.g., bending strength, elasticity, tensile strength, compressive strength). In embodiments, one or more of the layers is a honeycomb patterned material. In embodiments, one or more of the layers, or the composite of the plurality of layers has the ability to carry a shear load through it.

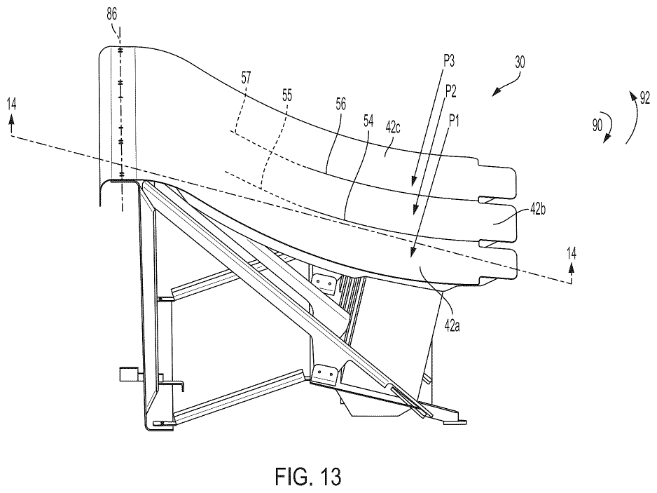

As shown in FIG. 4, seat member 42 is configured to be coupled to front wall 34 adjacent forward extent 58, and seat member 42 is coupled to front wall 34 along a connection axis 86 (FIG. 13). Seat member 42 extends rearwardly and acts in a similar manner to a cantilevered beam, such that seat member 42 is movable (e.g., flexes, actuates, or deflects) about connection axis 86. As shown in FIG. 4, seat member 42 is in a neutral, or unloaded position. When a force F is applied downwardly on seat member 42, seat member 42 is configured to rotate generally downwardly in rotational direction 90. In some embodiments, seat member 42 is elastic, or semielastic, and may rotate generally upwardly in rotational direction 92 to return to the neutral, or unloaded position. In some embodiments, an occupant of bench 30 may be seated on seat member 42 and the weight of the occupant exerts a downward force F on seat member 42. Bench 30 may be configured to have one or more occupants positioned in a standard seating position such that the force F is exerted on seat 42 at a position 88 which is a length L5 behind the forward extent 58 of seat member 42. In some embodiments, position 88 is the position at which the lumbar force of a passenger is applied (e.g., generally the position of the pelvis on seat member 42).

FIG. 10 is a top view of the seat member 42. As shown in FIG. 10, each of first weakened portion 54 and second weakened portion 56 extend forwardly from rearward extent 59 of seat member 42. As shown, first weakened portion 54 extends forwardly from second notch 53b and second weakened portion 56 extends forwardly from third notch 53c. In some embodiments, first weakened portion 54 extends forwardly from rearward extent 59 a length L2 to a forward termination point 94 and second weakened portion 56 extends forwardly from rearward extent 59 length L2 to a forward termination point 96. In some embodiments, each of forward termination points 94, 96 are positioned a length L3 rearwardly of the forward extent 58. In some embodiments, each of first weakened portion 54 and second weakened portion 56 have a length L4. In some embodiments, each of lengths L1, L2, L3, L4, L5 may be defined as straightline values (e.g., a straightline between points). In other embodiments, each of lengths L1, L2, L3, L4, L5 may be defined by their curvilinear values as measured along a surface of the seat member 42 (e.g., a curvilinear line defined by the surface of the seat member 42).

In some embodiments, length L3 is between 25%-75% of length L5, and in further embodiments, length L3 is between 40-60% of length L5, and in some embodiments, length L3 is approximately 50% of length L5. In some embodiments, length L3 is greater than 25% of length L1. In some embodiments, length L3 is greater than 50% of length L1. In some embodiments, length L4 is between 25%-75% of length L1, and in further embodiments, length L4 is between 40-60% of length L1.

As shown in FIG. 10, each of first weakened portion 54 and second weakened portion 56 are through-cuts through each of top layer 80, middle layer 82, and bottom layer 84 (i.e., first weakened portion 54 is a physical separation between first seat portion 42a and second seat portion 42b and second weakened portion 56 is a physical separation between second seat portion 42b and third seat portion 42c). In some embodiments, first weakened portion 54 includes a third weakened portion 55 which extends forwardly from termination point 94. In some embodiments, third weakened portion 55 extends forwardly to forward extent 58 of seat member 42. Further, in some embodiments second weakened portion 56 includes a fourth weakened portion 57 fourth weakened portion 57 which extends forwardly from termination point 96. In some embodiments, fourth weakened portion 57 fourth weakened portion 57 extends forwardly to forward extent 58 of seat member 42. In some embodiments, each of third weakened portion 55 and fourth weakened portion 57 are weakened portions (e.g., score lines, or fault lines) which do not provide complete separation between first seat portion 42a, second seat portion 42b, and third seat portion 42c, respectively. In some embodiments, each of first weakened portion 54 and second weakened portion 56 are constructed by applying a through-cut to the seat member 42 after each of the layers 80, 82, 84 are joined. Each of first weakened portion 54 and second weakened portion 56 are optionally constructed by applying a through-cut to each of the layers 80, 82, 84 of the seat member 42 before each of the layers 80, 82, 84 are joined. Each of the third weakened portion 55 and fourth weakened portion 57 can be constructed by applying a through-cut to one or more of the layers 80, 82, 84 before each of the layers 80, 82, 84 are joined. In some embodiments, each of the third weakened portion 55 and fourth weakened portion 57 are constructed by applying a through-cut top one or more of the layers 80, 82, 84 after each of the layers 80, 82, 84 are joined.

As indicated in FIG. 13, each of first weakened portion 54 and second weakened portion 56 are weakened portions relative to first seat portion 42a, second seat portion 42b, and third seat portion 42c and each of first seat portion 42a, second seat portion 42b, and third seat portion 42c may move independent of each other due to the difference in material strength or absence of material at the first weakened portion 54 and second weakened portion 56. That is, first seat portion 42a may flex or deflect about connection axis 86 independent of each of second seat portion 42b and third seat portion 42c, second seat portion 42b may flex or deflect about connection axis 86 independent of each of first seat portion 42a and third seat portion 42c, and third seat portion 42c may flex or deflect about connection axis 86 independent of each of first seat portion 42a and second seat portion 42b. In some embodiments, each of first seat portion 42a, second seat portion 42b, and third seat portion 42c are interconnected, and may deflect semi-independently of each other and residual stresses may be transmitted between each of first seat portion 42a, second seat portion 42b, and third seat portion 42c. That is, for example, a force applied to first seat portion 42a may primarily exert a force on first seat portion 42a, however, because each of first seat portion 42a, second seat portion 42b, and third seat portion 42c may be interconnected, one or both of second seat portion 42b and third seat portion 42c may experience residual forces due to the force applied to first seat portion 42a.

As indicated in FIG. 13, each of first seat portion 42a, second seat portion 42b, and third seat portion 42c are configured to receive a downward force from, for example, a passenger of airplane 10 (e.g., the weight of the user as further accelerated by a hard landing, impact, or other downward force). In some embodiments, a first passenger exerts a first force P1 downward on first seat portion 42a, a second passenger exerts a second force P2 downward on second seat portion 42b, and a third passenger exerts a third force P3 downward on third seat portion 42c. That is, first force P1 exerts a moment force on first seat portion 42a about connection axis 86, second force P2 exerts a moment force on second seat portion 42b about connection axis 86, and third force P3 exerts a moment force on third seat portion 42c about connection axis 86. In some embodiments, each of first seat portion 42a, second seat portion 42b, and third seat portion 42c are configured to deflect a minimal amount (e.g., between 0 in-4 in) under an average passenger load (e.g., an average passenger sitting exerts between 70-300 pounds of force, and may be approximately 200 pounds). In some embodiments, each of first seat portion 42a, second seat portion 42b, and third seat portion 42c are configured not to deflect under an average passenger load (e.g., an average passenger sitting exerts between 70-300 pounds of force and may be approximately 200 pounds).

In some embodiments, bench 30 includes a layer (not shown) that is coupled to the top of one or more of first seat portion 42a, second seat portion 42b, and third seat portion 42c. In embodiments, the top layer of one or more of first seat portion 42a, second seat portion 42b, and third seat portion 42c is a cushion layer made out of a foam like material configured to absorb forces. The cushion layer may be configured to absorber the forces of an average passenger load (e.g., an average passenger sitting exerts between 70-300 pounds of force and may be approximately 200 pounds) and the first seat portion 42a, second seat portion 42b, and third seat portion 42c do not deflect under the forces of the average passenger load because all of the forces of the average passenger load are absorbed by the cushion layer. In embodiments, the average passenger load is a static load. In embodiments, first seat portion 42a, second seat portion 42b, and third seat portion 42c are configured to elastically deflect (e.g., deflect and return back to the nominally original shape) under the forces of an average passenger load through a typical flight regime or flight operations (e.g., turbulence). In embodiments, an average passenger load may increase up to 6× during the course of a typical flight regime (e.g., average passenger load may increase up to 420-1800 pounds, and may be 1200 pounds). That is, each of first seat portion 42a, second seat portion 42b, and third seat portion 42c are configured to elastically deflect when the passenger load is up to and below 420-1800 pounds and may be up to and below 1200 pounds. In embodiments, a passenger load greater than the average passenger load during a typical flight regime may indicate an emergency landing (e.g., by parachute), and each of first seat portion 42a, second seat portion 42b, and third seat portion 42c are configured to deflect past an elastic region and contact one or more of loading members 40.

Seat member 42 includes first weakened portion 54, second weakened portion 56 and each of third weakened portion 55 and fourth weakened portion 57 to allow independent movement of first seat portion 42a, second seat portion 42b, and third seat portion 42c relative to each other. The relative ability of each of first seat portion 42a, second seat portion 42b, and third seat portion 42c to bend, or deflect, relative to one another is dependent upon the length of each of first weakened portion 54, second weakened portion 56, third weakened portion 55, and fourth weakened portion 57. That is, as first weakened portion 54 is increased in length, the separation between first seat portion 42a and second seat portion 42b is increased and each of first seat portion 42a and second seat portion 42b may deflect more easily relative to one another (e.g., under a specific weight, first seat portion 42a and second seat portion 42b will deflect more relative to one another as first weakened portion 54 is lengthened). Further, as second weakened portion 56 is increased in length, the separation between second seat portion 42b and third seat portion 42c is increased and each of second seat portion 42b and third seat portion 42c may deflect more easily relative to one another (e.g., under a specific weight, second seat portion 42b and third seat portion 42c will deflect more relative to one another as second weakened portion 56 is lengthened). Additionally, as first weakened portion 54 is decreased in length, the separation between first seat portion 42a and second seat portion 42b is decreased and each of first seat portion 42a and second seat portion 42b may deflect less easily relative to one another (e.g., under a specific weight, first seat portion 42a and second seat portion 42b will deflect less relative to one another as first weakened portion 54 is shortened). Further, as second weakened portion 56 is decreased in length, the separation between second seat portion 42b and third seat portion 42c is decreased and each of second seat portion 42b and third seat portion 42c may deflect less easily relative to one another (e.g., under a specific weight, second seat portion 42b and third seat portion 42c will deflect less relative to one another as second weakened portion 56 is shortened).

In some embodiments, third weakened portion 55 and fourth weakened portion 57 are weakened portions relative to first seat portion 42a, second seat portion 42b, and third seat portion 42c. In some embodiments, third weakened portion 55 and fourth weakened portion 57 are created by a through-cut in at least one layer of the plurality of layers (e.g., top layer 80, middle layer 82, bottom layer 84) of first body portion 62, second body portion 64, and third body portion 66. In some embodiments, each of third weakened portion 55 and fourth weakened portion 57 are defined by a through cut through each of the middle layer 82 and bottom layer 84. A through cut through at least one layer of the plurality of layers decreases the strength of third weakened portion 55 and fourth weakened portion 57 relative to first seat portion 42a, second seat portion 42b, and third seat portion 42c.

In some embodiments, third weakened portion 55 and fourth weakened portion 57 fourth weakened portion 57 are constructed (e.g., sized and shaped) to tear, yield, or otherwise fail at a predetermined force that is greater than the average passenger load. That is, when first force P1 exceeds a first predetermined force or second force P2 exceeds a second predetermined force, third weakened portion 55 is configured to tear, yield, or otherwise fail, and allow either of, or both of, first seat portion 42a and second seat portion 42b to deflect downwardly. Further, when second force P2 exceeds the second predetermined force or third force P3 exceeds a third predetermined force, fourth weakened portion 57 is configured to tear, yield, or otherwise fail, and allow either of, or both of, second seat portion 42b and third seat portion 42c to deflect downwardly.

In some embodiments, aircraft 10 may experience a generally vertical force when landing using a parachute system (not shown). That is, when aircraft 10 impacts the ground using the parachute system, a belly (not shown) of the aircraft 10 may first impact the ground, and at least a portion of the impact force may be transmitted into the bench 30. Each passenger sitting on bench 30 will exert a reactionary force downwardly onto bench 30. That is, a first passenger exerts first force P1 as a reactionary force onto first seat portion 42a, second passenger exerts second force P2 as a reactionary force onto second seat portion 42b, and third passenger exerts third force P3 as a reactionary force onto third seat portion 42c. In some embodiments, each passenger may be the same weight or may be a different weight, and passengers with different weights may exert different forces onto their respective seat portion. That is, for example, a first passenger has a first weight sitting on first seat portion 42a and a second passenger has a second weight sitting on second seat portion 42b and the first weight is greater than the second weight, and the reactionary force of the first passenger onto the first seat portion 42a may be greater than the reactionary force of the second passenger onto the second seat portion 42b.

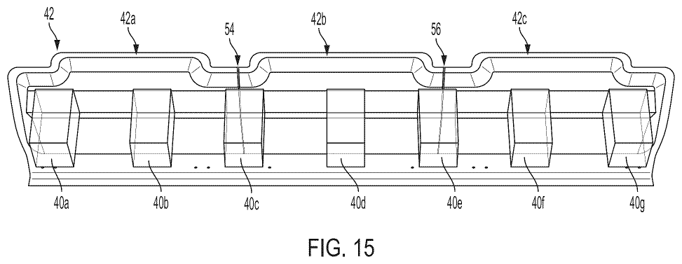

As shown in FIG. 15, loading members 40a, 40b, and 40c are configured to support first seat portion 42a, loading members 40c, 40d, 40e are configured to support second seat portion 42b, and loading members 40e, 40f, 40g are configured to support third seat portion 42c. Loading members 40a, 40b are configured to solely support first seat portion 42a, loading member 40d is configured to solely support second seat portion 42b, and loading members 40f, 40g are configured to solely support third seat portion 42c, and loading member 40c is configured to support each of first seat portion 42a and second seat portion 42b and loading member 40e is configured to support each of second seat portion 42b and third seat portion 42c. In some embodiments, loading member 40c is laterally aligned with first weakened portion 54 and loading member 40e is laterally aligned with second weakened portion 56. In some embodiments, each loading member 40 is configured to solely support only one seat portion (i.e., no loading members 40 are laterally aligned with either first weakened portion 54 or second weakened portion 56). In some embodiments, each loading member 40c, 40e is larger than loading members 40a, 40b, 40d, 40f, 40g.

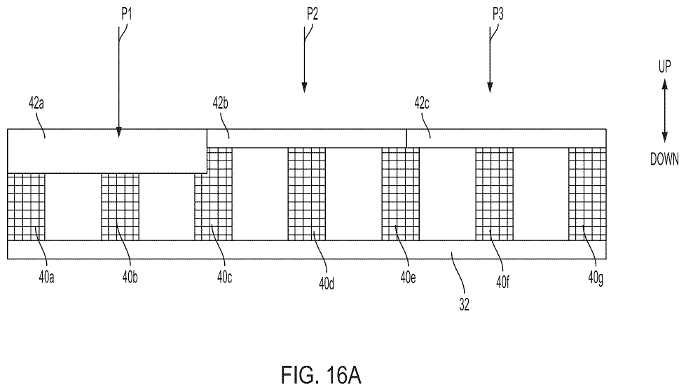

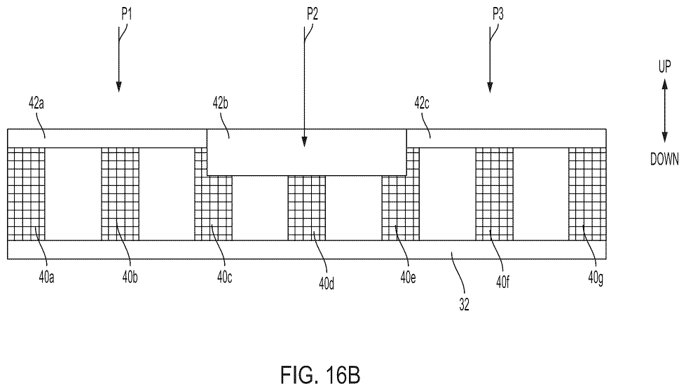

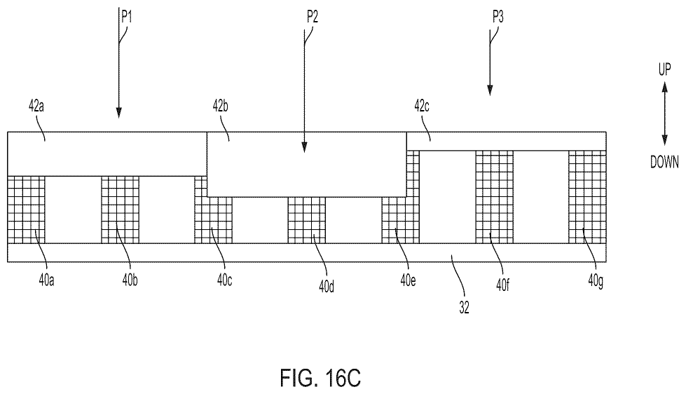

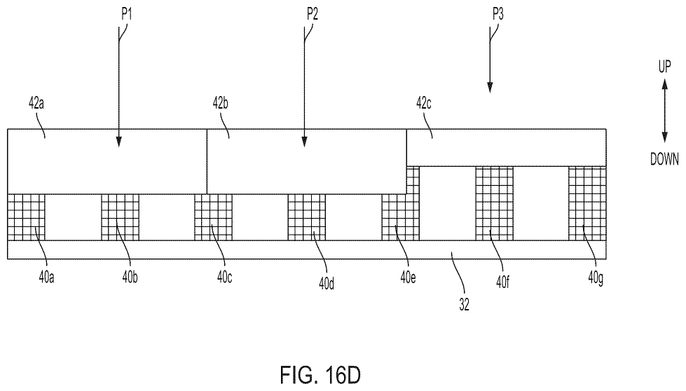

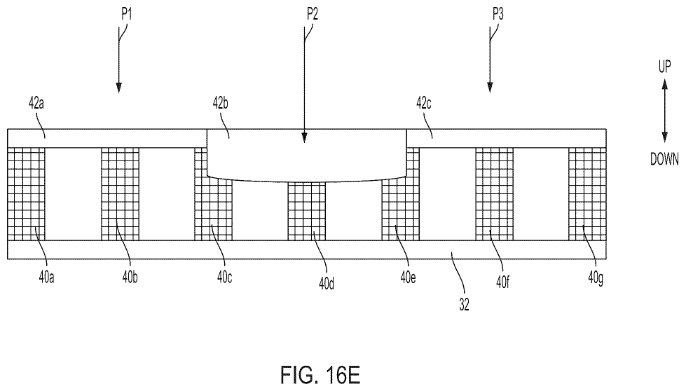

As shown in FIG. 16A, first force P1 is greater than each of second force P2 and third force P3, and first seat portion 42a is deflected downwardly relative to each of second seat portion 42b and third seat portion 42c and each of loading members 40a, 40b, and 40c compress in response to the deflection of first seat portion 42a. That is, third weakened portion 55 is torn, or otherwise broken, in response to the deflection of first seat portion 42a relative to second seat portion 42b under first force P1. Each of loading members 40a, 40b compress generally uniformly and in an equal amount, while loading member 40c compresses non-uniformly because it only partially supports first seat portion 42a. In some embodiments, one or more of loading members 40a-40g deform in a curved manner (e.g., parabolic or curvilinear). Loading member 40c is zonally responsive to the first force P1 and only a portion of third loading member 40c is compressed under the load of first force P1.

As shown in FIG. 16B, second force P2 is greater than each of first force P1 and third force P3, and second seat portion 42b is deflected downwardly relative to each of first seat portion 42a and third seat portion 42c and each of loading members 40c, 40d, 40e compress in response to the deflection of second seat portion 42b. That is, third weakened portion 55 and fourth weakened portion 57 are torn, or otherwise broken, in response to the deflection of second seat portion 42b relative to first seat portion 42a and third seat portion 42c under second force P2. Loading member 40d is compressed generally uniformly because it solely supports second seat portion 42b. Each of third loading member 40c and fifth loading member 40e compress partially, or non-uniformly because they each partially support second seat portion 42b. In some embodiments, one or more of loading members 40a-40g deform in a curved manner (e.g., parabolic or curvilinear). Loading member 40c and loading member 40e are zonally responsive to the second force P2 and only a portion of third loading member 40c and fifth loading member 40e are compressed under the load of second force P2.

As shown in FIG. 16C, second force P2 is greater than first force P1, and first force P1 is greater than third force P3, and in response to each of first force P1, second force P3, and third force P3, second seat portion 42b is deflected downwardly more than each of first seat portion 42a and third seat portion 42c and first seat portion 42a is deflected downwardly relative to third seat portion 42c. Each of loading members 40a-40g compress in response to the deflection of each seat portions 42a, 42b, 42c. That is, fourth weakened portion 57 is torn, or otherwise broken, in response to the deflection of second seat portion 42b relative to third seat portion 42c under second force P2. In various embodiments, third weakened portion 55 may be partially or fully turn, or otherwise broken, in response to the deflection of second seat portion 42b relative to first seat portion 42a. That is, both first seat portion 42a and second seat portion 42b deflect and first force P1 may be similar, or close enough, to first force P1 that first seat portion 42a and second seat portion 42b deflect a commensurate amount and third weakened portion 55 does not fully tear. Each of loading members 40a, 40b compress generally uniformly in response to the first force P1, loading member 40d compresses generally uniformly in response to the second force P2, and each of loading members 40f, 40g compress generally uniformly in response to the third force P3. Loading member 40c compresses non-uniformly in response to each of first force P1 and second force P2. In some embodiments, one or more of loading members 40a-40g deform in a curved manner (e.g., parabolic or curvilinear). Loading member 40c is zonally response to each of first force P1 and second force P2 and a first portion of loading member 40c is compressed a first distance in response to first force P1 and a second portion of loading member 40c is compressed a second distance in response second force P2.

As shown in FIG. 16D, first force P1 is equal, or approximately equal, to second force P2, and third force P3 is less than each of first force P1 and second force P2, and in response to the first force P1 and second force P2 each of first seat portion 42a and second seat portion 42b are deflected an approximately equal amount and third seat portion 42c is deflected less relative to each of first seat portion 42a and second seat portion 42b. That is, both first seat portion 42a and second seat portion 42b deflect and first force P1 may be similar, or close enough, to second force P2 that first seat portion 42a and second seat portion 42b deflect a commensurate amount and third weakened portion 55 does not fully tear. Each of loading members 40a, 40b, 40d are compressed generally uniformly because the solely support either of first seat portion 42a or second seat portion 42b. Further, loading member 40c is compressed generally uniformly because first force P1 is approximately equal to second force P2 causing each of first seat portion 42a and second seat portion 42b to deflect an approximately equal amount. In some embodiments, one or more of loading members 40a-40g deform in a curved manner (e.g., parabolic or curvilinear). Loading member 40e is zonally responsive to each of second force P2 and third force P3 and a first portion of loading member 40e is compressed a first distance in response to second force P2 and a second portion of loading member 40e is compressed a second distance in response third force P2.

As shown in FIG. 16E, second force P2 is greater than each of first force P1 and third force P3, and second seat portion 42b is deflected downwardly relative to each of first seat portion 42a and third seat portion 42c and each of loading members 40c, 40d, 40e compress in response to the deflection of second seat portion 42b. That is, third weakened portion 55 and fourth weakened portion 57 are torn, or otherwise broken, in response to the deflection of second seat portion 42b relative to first seat portion 42a and third seat portion 42c under second force P2. In some embodiments loading member 40d is compressed in a generally curved manner due to the center of the dispersed second force P2. Each of third loading member 40c and fifth loading member 40e compress partially, or non-uniformly because they each partially support second seat portion 42b. In some embodiments, one or more of loading members 40a-40g deform in a curved manner (e.g., parabolic or curvilinear). Loading member 40c and loading member 40e are zonally responsive to the second force P2 and only a portion of third loading member 40c and fifth loading member 40e are compressed under the load of second force P2.

Referring to FIGS. 16A-16E, each of third weakened portion 55 and fourth weakened portion 57 are configured to tear, or experience a tearing force, when the force exerted on any of first seat portion 42a, second seat portion 42b, and third seat portion 42c is greater than the predetermined passenger load through a standard flight regime (e.g., the predetermined passenger load through a standard flight regime may be 420-1800 pounds, or may be approximately 1200 pounds). That is, after any of first seat portion 42a, second seat portion 42b, and third seat portion 42c experiences the tearing force, the respective first seat portion 42a, second seat portion 42b, and third seat portion 42c is configured to non-elastically deflect and engage one or more loading members 40a-40g. In some embodiments, tearing one or more of third weakened portion 55 and fourth weakened portion 57 requires energy which will be absorbed by the seat pan (e.g., at third weakened portion 55 and fourth weakened portion 57) and that energy created by the tearing force will not be imparted to loading members 40a-40g. That is, loading members 40a-40g may be sized according to the size, strength, and resiliency of the third weakened portion 55 and fourth weakened portion 57. In some embodiments, if seat member 42 includes one or more of the tearable third weakened portion 55 and fourth weakened portion 57, one or more loading members 40a-40g may be a smaller size or configured to carry less load. Conversely, if seat member 42 does not include a tearable portion (e.g., third weakened portion 55 or fourth weakened portion 57), one or more loading members 40a-40g may be larger in size or configured to carry a higher load.

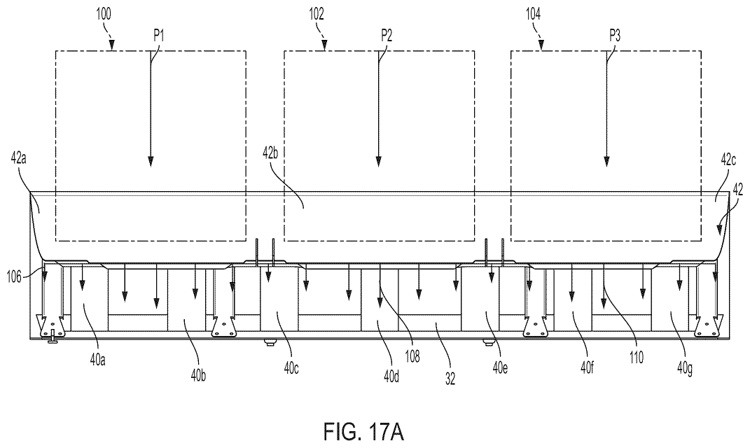

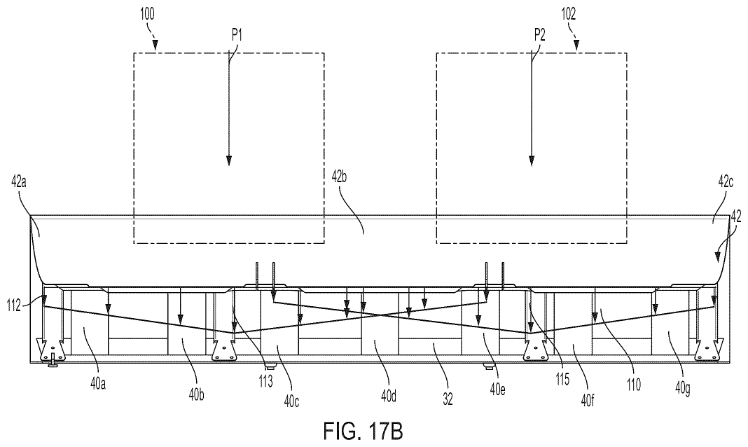

As shown in FIGS. 17A-17B, seat member 42 may be configured to disperse the downward force of the passengers according to the number of passengers and the position of the passengers. In some embodiments, seat member 42 is configured to receive one or more passengers in a variety of seating positions. As shown in FIG. 17A, seat member 42 is configured to receive a first passenger 100 on first seat portion 42a, a second passenger 102 on second seat portion 42b, and a third passenger 104 on third seat portion 42c. In this configuration, a single passenger is configured to be received by each seat portion 42a, 42b, 42c. Further, in this configuration, under the load of first force P1, seat portion 42a deflects relative to seat portion 42b and third weakened portion 55 is configured to tear to allow greater deflection of seat portion 42a and the compression of loading members 40a, 40b, 40c. In this configuration, under the load of second force P2, seat portion 42b deflects relative to seat portions 42a, 42c and third weakened portion 55 and fourth weakened portion 57 is configured to tear to allow greater deflection of seat portion 42b and the compression of loading members 40c, 40d, 40e. In this configuration, under the load of third force P3, seat portion 42c deflects relative to seat portions 42b and fourth weakened portion 57 is configured to tear to allow greater deflection of seat portion 42c and the compression of loading members 40e, 40f, 40g.

As shown in FIG. 17B, seat member 42 is configured to receive a pair of passengers, including first passenger 100 and second passenger 102. First passenger 100 is configured to be seated at a position that overlaps first weakened portion 54 and third weakened portion 55 and second passenger 102 is configured to be seated at a position that overlaps second weakened portion 56 and fourth weakened portion 57. That is, first passenger 100 is configured to be supported by each of first seat portion 42a and second seat portion 42b and second passenger 102 is configured to be supported by each of second seat portion 42b and third seat portion 42c. That is, first passenger 100 is configured to be supported by each of first seat portion 42a and second seat portion 42b and supported by each of loading members 40a, 40b, 40c, 40d, and 40e. Further, passenger 102 is configured to be supported by each of second seat portion 42b and third seat portion 42c and supported by each of loading members 40c, 40d, 40e, 40f, and 40g. In this configuration, under the load of first force P1, seat portions 42a, 42b deflect relative to seat portions 42c and fourth weakened portion 57 is configured to tear to allow greater deflection of seat portions 42a, 42b and the compression of loading members 40a, 40b, 40c, 40d, 40e.

As shown in FIG. 17A, first passenger 100 exerts first force P1 downwardly on first seat portion 42a, and a first force gradient 106 is created along first seat portion 42a. Illustratively, a portion of first force gradient 106 is localized to first seat portion 42a. In some embodiments, based upon the length and/or strength of first weakened portion 54 and third weakened portion 55, the first force gradient 106 may extend along seat member 42 to second seat portion 42b and may extend along seat member 42 to third seat portion 42c. Second passenger 102 exerts second force P2 downwardly on second seat portion 42b, and a second force gradient 108 is created along second seat portion 42b. Illustratively, a portion of second force gradient 108 is localized to second seat portion 42b. In some embodiments, based upon the length and strength of first weakened portion 54 and third weakened portion 55, the second force gradient 108 may extend along seat member 42 to first seat portion 42a and based upon the length and strength of second weakened portion 56 and fourth weakened portion 57, the second force gradient 108 may extend along may extend along seat member 42 to third seat portion 42c. Further, third passenger 104 exerts third force P3 downwardly on third seat portion 42c, and a third force gradient 110 is created along third seat portion 42c. Illustratively, a portion of third force gradient 110 is localized to third seat portion 42c. In some embodiments, based upon the length and/or strength of second weakened portion 56 and fourth weakened portion 57, the third force gradient 110 may extend along seat member 42 to second seat portion 42b and may extend along seat member 42 to first seat portion 42a.

As shown in FIG. 17B, each of loading members 40c, 40e are laterally aligned with first weakened portion 54 and second weakened portion 56, respectively. First passenger 100 exerts first force P1 downwardly on each of first seat portion 42a and second seat portion 42b. A force gradient 112 is created along each of first seat portion 42a and second seat portion 42b and a localized force maximum 113 may be found laterally aligned with first force P1. The force gradient 112 extends along each of first seat portion 42a and second seat portion 42b and, in some embodiments, residual forces may be transmitted to third seat portion 42c. Second passenger 102 exerts second force P2 downwardly on each of third seat portion 42c and second seat portion 42b. A force gradient 114 is created along each of third seat portion 42c and second seat portion 42b and a localized force maximum 115 may be found laterally aligned with second force P2. The force gradient 114 extends along each of third seat portion 42c and second seat portion 42b and, in some embodiments, residual forces may be transmitted to first seat portion 42a. In some embodiments, the force gradients 112, 114 may overlap.

As shown in FIGS. 17A-17B, force gradients 106, 108, 110, 112, 114 may be linear force gradients (as shown), or may otherwise be curvilinear. In some embodiments, force gradients 106, 108, 110, 112, 114 are defined based upon a plurality of characteristics including the material and/or thickness of any of layers 80, 82, 84, the length of any of first weakened portion 54, second weakened portion 56, third weakened portion 55, or fourth weakened portion 57, and the strength of third weakened portion 55 and fourth weakened portion 57.

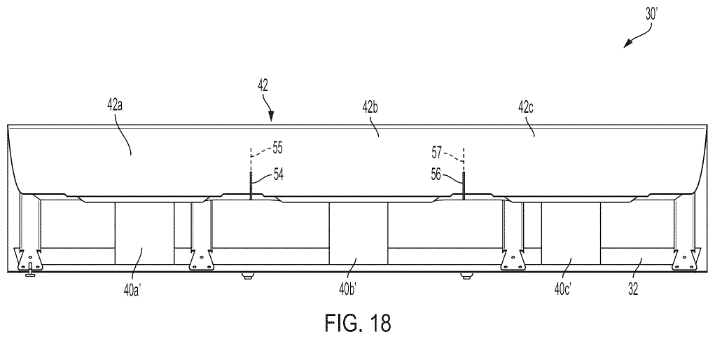

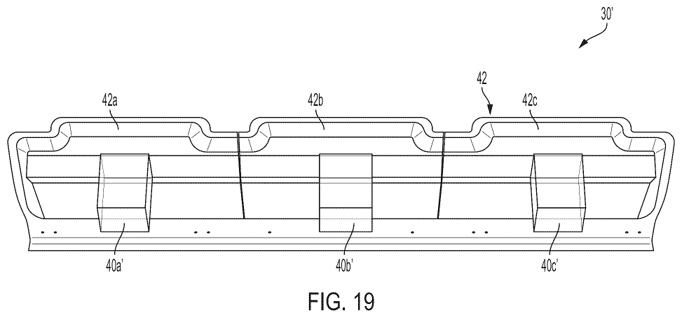

FIGS. 18-19 illustrate another bench configuration according to various embodiments in the form of bench 30′. As shown in FIGS. 18-19, bench 30′ includes three loading members 40. That is, bench 30′ includes a first loading member 40a′ extending between base member 32 and first seat portion 42a, a second loading member 40b′ extending between base member 32 and second seat portion 42b, and a third loading member 40c′ extending between base member 32 and third seat portion 42c. Loading member 40a′ solely supports first seat portion 42a, loading member 40b′ solely supports second seat portion 42b, and loading member 40c′ solely supports third seat portion 42c. In some embodiments, bench 30′ may include a pair of loading members solely supporting each seat portion. That is, a pair of loading members 40 may solely support first seat portion 42a, a pair of loading members 40 may solely support second seat portion 42b, and a pair of loading members 40 may solely support third seat portion 42c. In some embodiments, bench 30′ is configured so that no loading members 40 are laterally aligned with any of first weakened portion 54, second weakened portion 56, third weakened portion 55, or fourth weakened portion 57. Loading members 40a′, 40b′, 40c′ may be similar to, or the same as, loading members 40a, 40b, 40c.

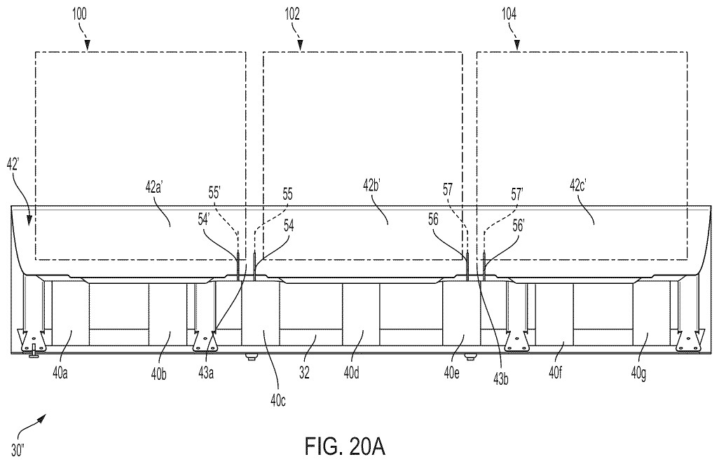

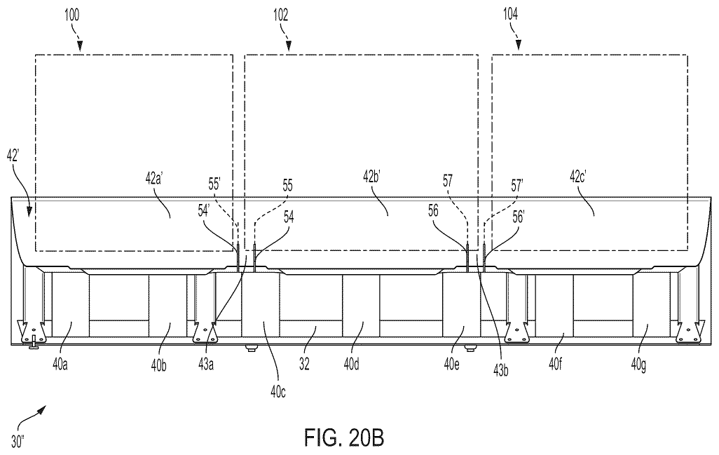

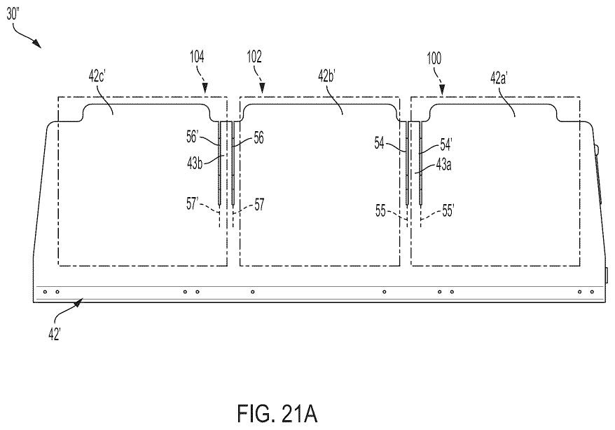

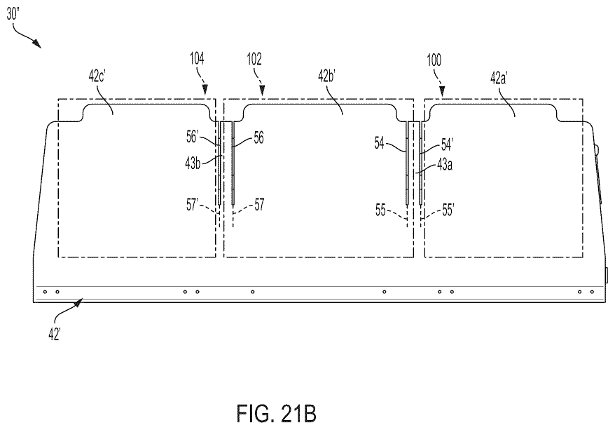

FIGS. 20A-21B illustrate another bench configuration according to various embodiments in the form of bench 30″. As shown in FIGS. 20A-20B, bench 30″ may include a seat member 42′ which may include a first seat portion 42a′, a second seat portion 42b′, and a third seat portion 42c′. First seat portion 42a′ is separated from second seat portion 42b′ by a first intermediate portion 43a, and second seat portion 42b′ is separated from third seat portion 42c′ by a second intermediate portion 43b. First seat portion 42a′ is separated from first intermediate portion 43a by a first weakened portion 54′ and first intermediate portion 43a is separated from second seat portion 42b′ by a second portion 54 (which may be similarly positioned as first weakened portion 54 of seat member 42). Second seat portion 42b′ is separated from second intermediate portion 43b by a third portion 56 (which may be similarly positioned as second weakened portion 56 of seat member 42) and second intermediate portion 43b is separated from second seat portion 42c′ by a fourth portion 56′. In some embodiments, each of first weakened portion 54′, second portion 54, third portion 56, and fourth portion 56′ are constructed similar to first weakened portion 54 and second weakened portion 56 of seat member 42. That is, each of first weakened portion 54′, second portion 54, third portion 56, and fourth portion 56′ are through-cuts configured to physically separate the respective portions of seat member 42′. In some embodiments, a fifth portion 55′ extends forward from first weakened portion 54′ (similar to third weakened portion 55 extending forward from first weakened portion 54) and a sixth portion 55 extends forward from second portion 54 (similar to third weakened portion 55 extending forward from first weakened portion 54). In some embodiments, a seventh portion 57 extends forward from third portion 56 (similar to fourth weakened portion 57 extending forward from second weakened portion 56) and an eighth portion 57′ extends forward from fourth portion 56′ (similar to third weakened portion 55 extending forward from first weakened portion 54).

Each of first intermediate portion 43a and second intermediate portion 43b are constructed with a layered structure similar to, or the same as, first seat portion 42a, second seat portion 42b, and third seat portion 42c. In some embodiments, first intermediate portion 43a, second intermediate portion 43b are constructed of fewer or more layers than the other body portions 42a, 42b, 42c. Each of intermediate portions 43a, 43b are configured to deflect relative to connection axis 86, similar to each of first seat portion 42a, second seat portion 42b, third seat portion 42c under a downward force (e.g., first force P1, second force P2, third force P3). Intermediate portions 43a, 43b are smaller than each of body portions 42a, 42b, 42c, and may be a different material structure in order to increase rigidity or strength.

In some embodiments, as shown in FIGS. 20A and 21A, seat member 42′ is configured to receive three-passengers according to a first passenger arrangement to allow for various passenger seating widths. First passenger 100 is configured to be received by each of first seat portion 42a′ and first intermediate portion 43a, second passenger 102 is configured to be received by second seat portion 42b′, and third passenger 104 is configured to be received by each of second intermediate portion 43b and third seat portion 42c′. That is, the lateral outward passengers (i.e., first passenger 100 and third passenger 104) have more lateral room than the middle passenger (i.e., second passenger 102). That is, the lateral outward passengers may utilize first intermediate portion 43a and second intermediate portion 43b to increase the lateral width of the outward seating areas.

In some embodiments, as shown in FIGS. 20B and 21B, seat member 42′ is configured to receive three passengers according to a second passenger arrangement to allow for various passenger seating widths. First passenger 100 is configured to be received by first seat portion 42a′, second passenger 102 is configured to be received by each of first intermediate portion 43a, second seat portion 42b′, and second intermediate portion 43b, and third passenger 104 is configured to be received by third seat portion 42c′. That is, the middle passenger (i.e., second passenger 102) has more lateral room than the lateral outward passengers (i.e., first passenger 100 and third passenger 104). That is, second passenger may utilize first intermediate portion 43a and second intermediate portion 43b to increase the lateral width of the middle seating area.

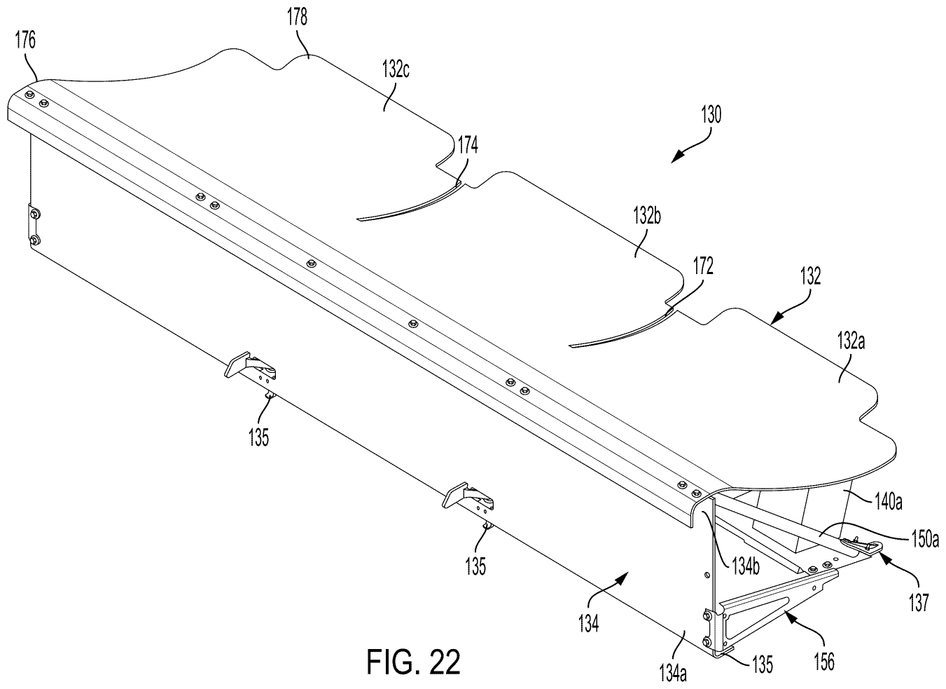

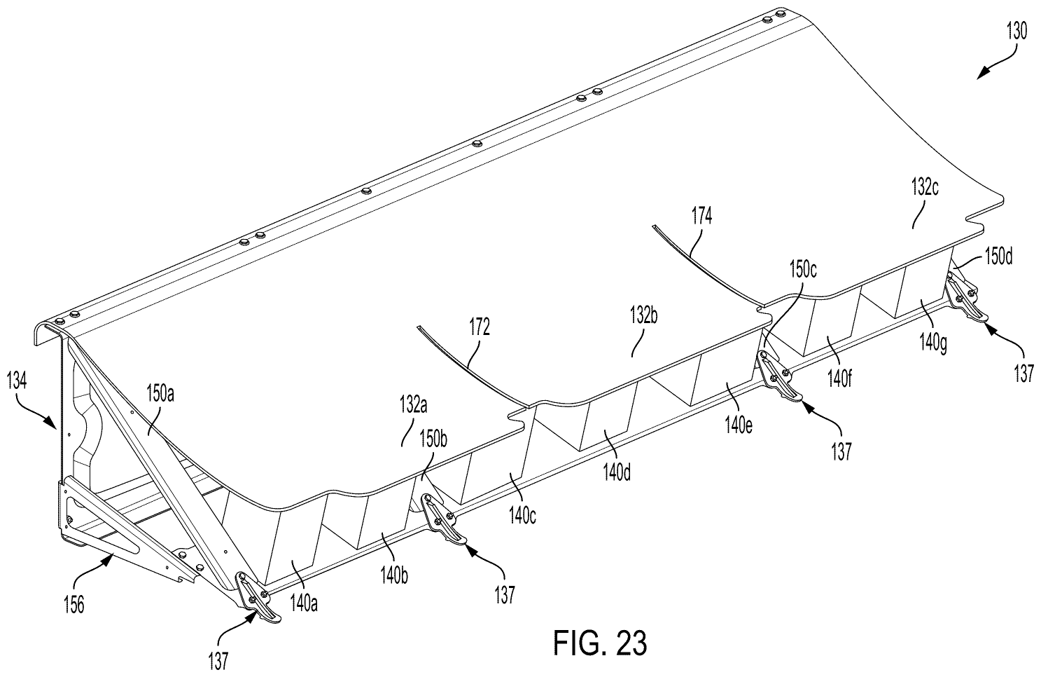

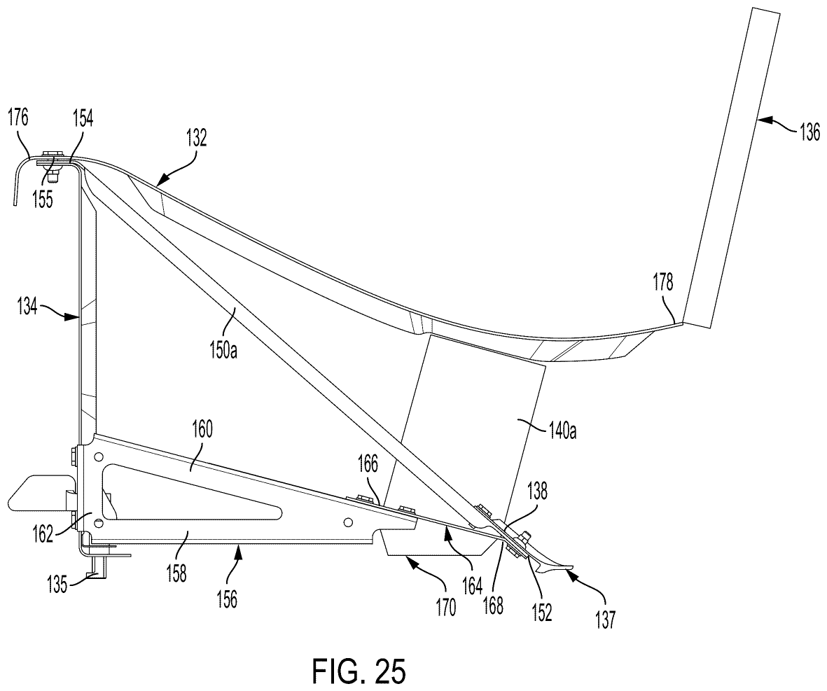

FIGS. 22-25 illustrate an alternate bench 130 including a seat 132. Seat 132 defines a front portion 176 and a rear portion 178. Seat 132 also defines a first portion 132a, a second portion 132b, and a third portion 132c. In embodiments, seat 132 is similar to or substantially the same as seat 42 (FIG. 8). Seat 132 includes a first weakened portion 172 separating first seat portion 132a and second seat portion 132b and a second weakened portion 174 separating second seat portion 132b and third seat portion 132c. In embodiments, first weakened portion 172 and second weakened portion 174 are similar to or substantially the same as first weakened portion 54 (FIG. 10) and second weakened portion 56 (FIG. 10) of seat 42. In the present embodiment, each of first weakened portion 172 and second weakened portion 174 is a weakened region (similar to first weakened portion 54, second weakened portion 56), or weakened portion relative to first seat portion 132a, second seat portion 132b, and third seat portion 132c. In embodiments, a seat back 136 is positioned adjacent to rear portion 178 of seat 132 and seat back 136 extends generally upwardly from rear portion 178. In embodiments, seat portions 132a, 132b, 132c rotate generally about an axis 155 extending laterally through front portion 176 of seat 132 (i.e., similar to seat portions 42a, 42b, 42c rotating about axis 86 (FIG. 4)). That is, seat portions 132a, 132b, 132c may rotate about axis 155 semi-independently of each other.

Bench 130 includes a front wall or vertically extending member 134 extending downwardly from front portion 176 and the front wall 134 includes a lower portion 134a and an upper portion 134b. A plurality of feet 135 are coupled to lower portion 134b of front wall 134. Feet 135 may couple to a floor of an aircraft, for example. Upper portion 134b of front wall 134 is coupled to front portion 176 of seat 132. A plurality of longitudinally extending braces or frame members 156 are coupled to lower portion 134a of front wall 134. In embodiments, bench 130 includes a plurality of laterally spaced braces 156. Longitudinally extending braces 156 are generally triangularly shaped and include a first member 158, a second member 160, and a third member 162. Second member 160 is positioned generally vertically above first member 158 and third member 162 is coupled between first member 158 and second member 160. Further, third member 162 is coupled to lower portion 134b of front wall 134. In embodiments, braces 156 are unitary members. In embodiments, braces 156 are formed of a plurality of members. Bench 130 includes a plurality of members 150, wherein each member 150 is positioned generally above (i.e., laterally aligned with) a brace 156. Members 150 include a first portion 152 and a second portion 154. Second portion 154 is coupled to each of seat 132 and front wall 134. In embodiments, members 150 include a plurality of laterally spaced apart members 150a, 150b, 150c, and 150d. Bench 130 includes a plurality of feet 137 positioned at a rearward extent of bench 130. Each first portion 152 of each member 150 is coupled to a foot or frame member 137. Feet 137 may be coupled to a floor of an aircraft. A plate 164 defines a first portion 166 and a second portion 168. First portion 166 of plate 164 may be coupled to each of braces 156 and second portion 168 may be coupled to each of feet 137. Plate 164 generally extends the lateral width of seat 130. In embodiments, plate 164 defines a body portion 170 extending downwardly toward a floor surface. Seat 132 extends generally rearwardly and is generally cantilevered over each of frame members 150, 156, 164, and 137.

Referring still to FIGS. 22-25, bench 130 includes a plurality of loading members 140 including a first loading member 140a, a second loading member 140b, a third loading member 140c, a fourth loading member 140d, a fifth loading member 140e, a sixth loading member 140f, and a seventh loading member 140g. In embodiments, loading members 140 sit on, or are coupled to, plate or frame member 164 and extend generally upwardly. Loading members 140 are generally shaped and positioned to extend between plate 164 and a bottom of seat 132. In embodiments, loading members 140 are similar to or substantially the same as loading members 40. That is, the plurality of loading members 140, also described as crush cores 140, are compressible members configured to crush, or compress, under predetermined loads. Loading members 140 are comprised of a plurality of sheets, or honeycomb structure of a primary material configured to withstand predetermined forces (e.g., normal forces). In some embodiments, the sheets of material are made of aluminum, steel, polyester, carbon fiber, plastic, or another material suitable for withstanding normal forces and absorbing energy. In some embodiments, a secondary material (e.g., a foam, plastic, or other material) is configured to be placed between the plurality of sheets, or honeycomb structure of the primary material. The primary material and secondary material may be different densities. Loading members 140 may compress in a non-uniform manner depending upon the location and degree of force applied to the loading members 140. That is, loading members 140 may be configured to compress according to the application of force applied to the loading member. In some embodiments, loading member 140 includes a first portion and a second portion that are configured to compress independently dependent upon the location and degree of force applied thereto. In other words, the first portion may receive a normal force and compress while the second portion does not receive a normal force and does not compress or otherwise maintains its shape. In some embodiments, loading member 140 comprises a plurality of portions, and any portion may deflect independent of the remaining plurality of portions. That is, loading member 140 may be zonally responsive to forces applied to different portions of loading member 140. In some embodiments, loading members 140 are constructed to minimize lateral deflection. In embodiments, loading members 140 may be narrower or wider than shown (e.g., any width) such that more or less loading members need to be used, respectively, or the spacing of the loading members 140 may be altered (e.g., be any spacing).

Loading members 140 are configured to receive and dissipate a downward normal force, a lateral shear force, and/or a longitudinal shear forces. In some embodiments, loading members 140 are constructed to absorb and decelerate a received force. That is, loading members 140 may receive a high impulse force (e.g., from a passenger) and absorb the impulse force and decelerate the force to a stand-still. In some embodiments, loading members 140 progressively decelerate the forces as loading member 140 compresses or deflects a greater amount.

Loading members 140a-140g may be comprised of different materials, different combinations of materials, or otherwise constructed differently from one another to accommodate various strengths. For example, when a force is applied to each of loading member 140c and loading member 140d, and loading member 140c may be configured to crush, or deform, a different amount than loading member 140d is configured to crush or deform.

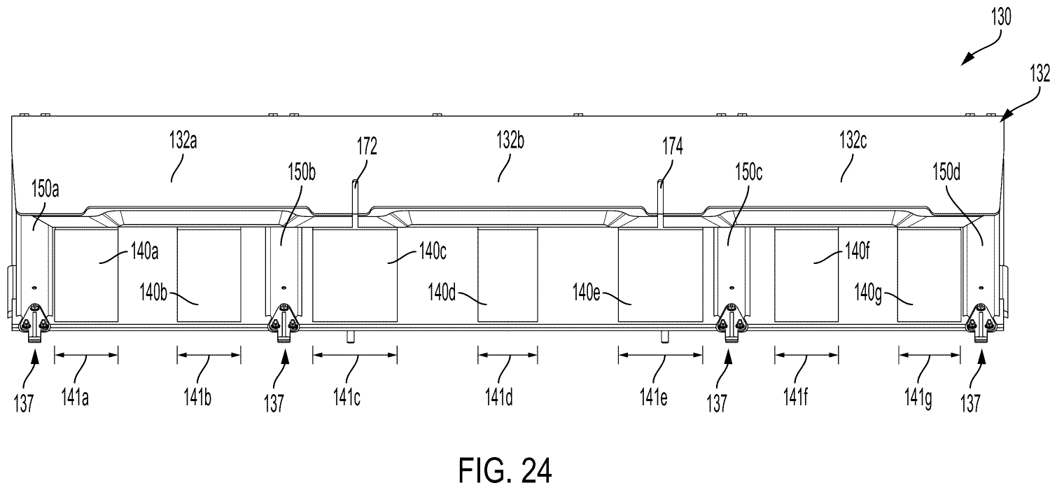

FIG. 24 illustrates a rear view of the bench 130 and each of the loading members 140 defines a lateral width 141. That is, first loading member 140a defines a first lateral width 141a, second loading member 140b defines a second lateral width 141b, third loading member 140c defines a third lateral width 141c, fourth loading member 140d defines a fourth lateral width 141d, fifth loading member 140e defines a fifth lateral width 141e, sixth loading member 140f defines a sixth lateral width 141f, and seventh loading member 140g defines a seventh lateral width 141g. In embodiments, each of first lateral width 141a, second lateral width 141b, fourth lateral width 141d, sixth lateral width 141f, and seventh lateral width 141g are the same width. In embodiments, each of third lateral width 141c and fifth lateral width 141e are the same width. In embodiments, each of lateral widths 141c, 141e are greater than lateral widths 141a, 141b, 141d, 141f, and 141g. In embodiments, each of loading members 140c, 140e are larger than loading members 140a, 140b, 140d, 140f, and 140g. Loading member 140c is positioned vertically below first weakened portion 172 and loading member 140e is positioned vertically below second weakened portion 174. Loading members 140c, 140e are larger than loading members 140a, 140b, 140d, 140f, 140g and positioned vertically below first weakened portion 172 and second weakened portion 174 to absorb a greater amount of force from one or more of seat portions 132a, 132b, 132c. Increasing the width of loading members 140c, 140e increases the surface area of loading members 140c, 140e on multiple seat portions 132a, 132b, 132c. That is, loading member 140c has an increased amount of surface area in contact with each of seat portions 132a, 132b relative to a loading member of decreased width in the same lateral position. Similarly, loading member 140e has an increased amount of surface area in contact with each of seat portions 132b, 132c relative to a loading member of decreased width in the same lateral position. In embodiments, lateral widths 141a, 141b, 141d, 141f, 141g are approximately 3 inches and lateral widths 141c, 141e are approximately 4 inches. In embodiments, lateral widths 141a, 141b, 141d, 141f, 141g are approximately 75% of lateral widths 141c, 141e.

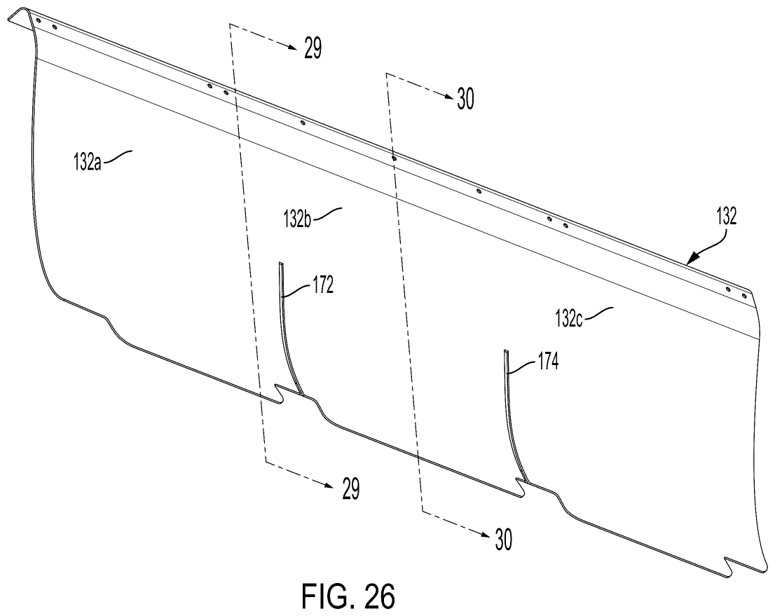

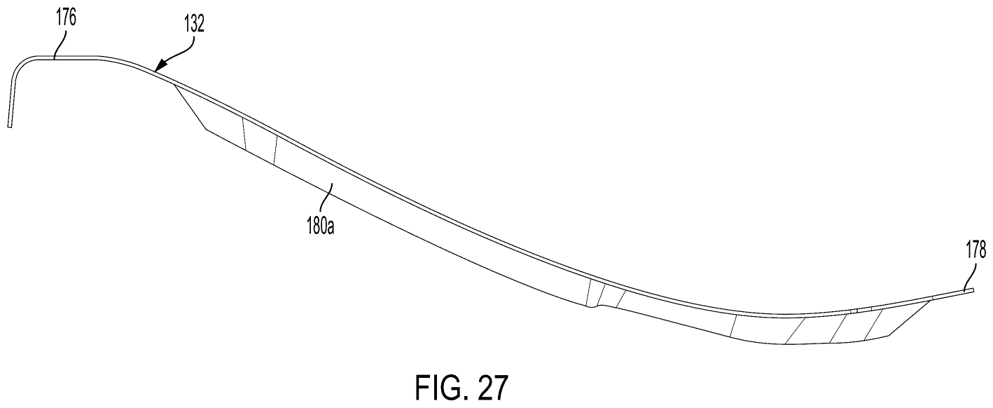

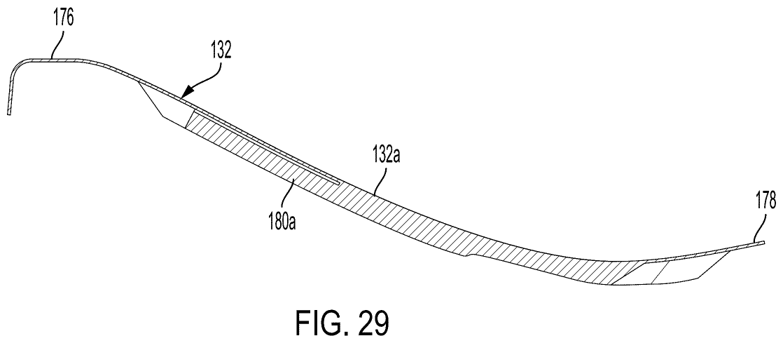

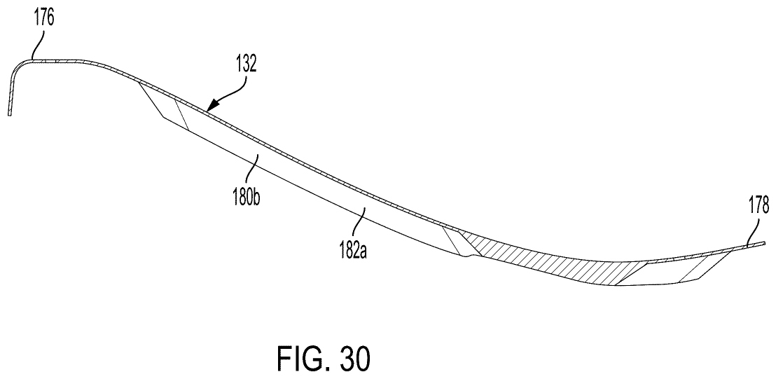

FIGS. 26-30 illustrate seat pan 132 and first seat portion 132a includes first body portion 180a, second seat portion 132b includes second body portion 180b, and third seat portion 132c includes third body portion 180c. Body portions 180a, 180b, 180c may be substantially similar to or the same as body portions 62, 64, 66 (FIG. 9). That is, body portions 180a, 180b, 180c may be formed of a composite structure.

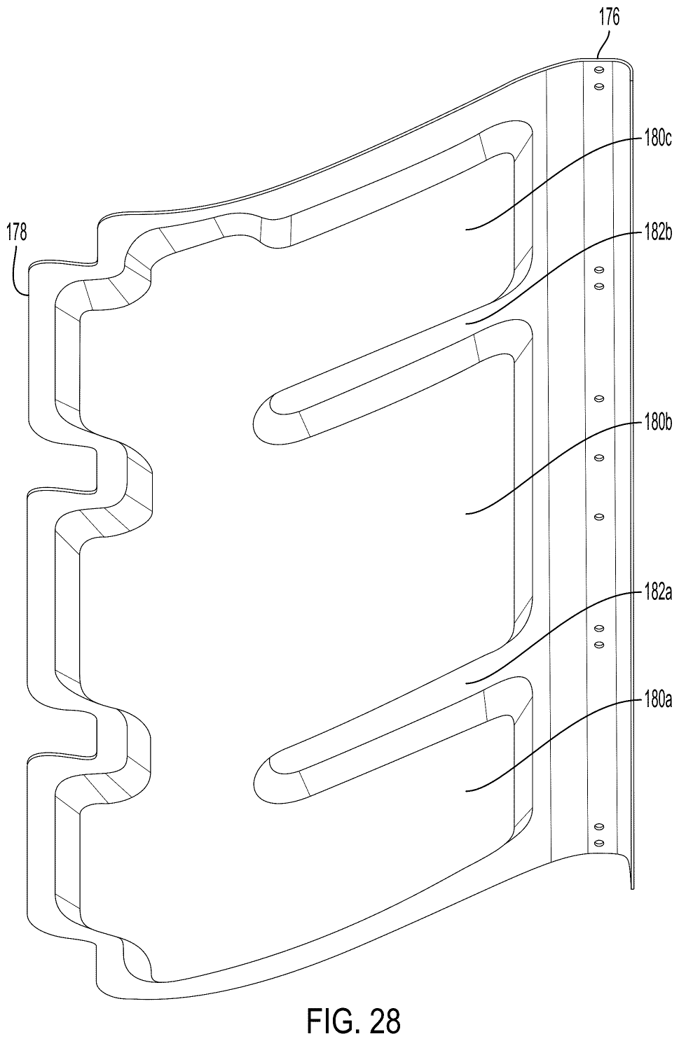

FIG. 28 illustrates a bottom view of seat pan 132 including a first recess 182a positioned laterally intermediate first body portion 180a and second body portion 180b and a second recess 182b positioned laterally intermediate second body portion 180b and third body portion 180c. First recess 182a may be laterally offset from first weakened portion 172 and second recess 182b may be laterally offset from second weakened portion 174. In embodiments, recesses 182a, 182b define a small absence of material within each of body portions 180a, 180b, 180c.

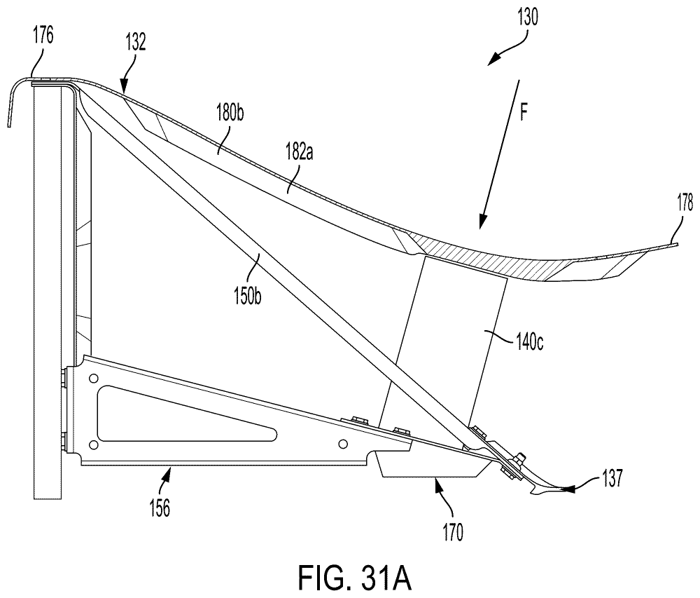

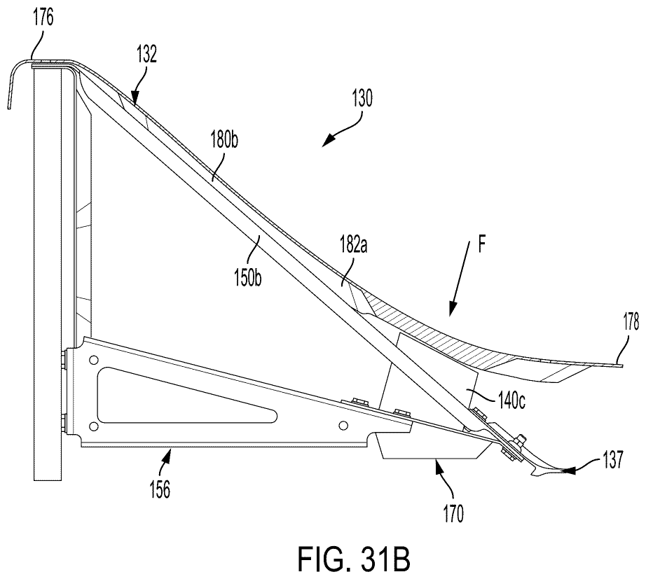

FIGS. 31A-31B illustrate a side view of bench 130. In embodiments, member 150b is laterally aligned with recess 182a and member 150c is laterally aligned with recess 182b. Recess 182 provides extra space for members 150 during rotation of seat portions 132a, 132b, 132c. That is, seat 132 may rotate (e.g., about axis 155) between a first position (e.g., undeflected position) and a second position (e.g., deflected position) based on varying forces imparted on seat 132. In embodiments, seat 132 may rotate between a plurality of positions depending on the force imparted on seat 132. Referring to FIG. 31A, during an undeflected use (e.g., force F is small enough to not substantially deflect or rotate seat portions 132a, 132b, 132c) of seat 132, seat portions 132a, 132, 132c generally do not rotate or rotate a minimal amount and do not substantially compress loading members 140. Referring to FIG. 31B, during a deflection use (e.g., force F is sufficient to deflect or rotate seat portions 132a, 132b, 132c and compress loading members 140), one or more of seat portions 132a, 132b, 132c rotate and compress one or more of loading members 140. During a deflection use, one or more of frame members 150, 156 may buckle and absorb a portion of the force F. During a deflection use, at least one of seat portions 132a, 132b, 132c rotates downwardly and may be positioned such that recesses 182 surround a portion of members 150 and an upper extent of members 150 extend above a bottom extent of body portions 180a, 180b, 180c. That is, recesses 182a, 182b within body portions 180a, 180b, 180c create more clearance for members 150 relative to seat 132 and allow seat 132 to rotate downwardly past an upper surface of members 150. During a deflection use, greater clearance for members 150 allows for greater rotation of seat 132 prior to ‘bottoming out’ or contacting members 150 which allows loading members 140 to absorb more of the force F. Minimizing or preventing a ‘bottom out’ situation also reduces the possibility of a sudden rotational stop or dampens the rotational stop of seat 132 thereby reducing upward reaction forces.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practices in the art to which this invention pertains.

1. A seat assembly, comprising:
a base assembly;
a seat pan supported by the base assembly;
a plurality of loading members positioned below the seat pan;
the seat pan, comprising:
a first seat portion supported by a first loading member of the plurality of loading members;
a second seat portion supported by a second loading member of the plurality of loading members;
a weakened portion extending longitudinally along the seat pan, the weakened portion positioned intermediate the first seat portion and the second seat portion.

2. The seat assembly of claim 1, wherein the first seat portion is configured to support a first passenger and the second seat portion is configured to support a second passenger.

3. The seat assembly of claim 1, wherein at least a portion of the first loading member is laterally aligned with the weakened portion.

4. The seat assembly of claim 1, wherein the seat pan further comprises a third seat portion positioned laterally intermediate the first seat portion and the second seat portion, and the weakened portion is a first weakened portion positioned intermediate the first seat portion and the third seat portion, and a second weakened portion extending longitudinally along a portion of the seat pan, the second weakened portion positioned intermediate the third seat portion and the second seat portion.

5. The seat assembly of claim 4, wherein at least a portion of the first loading member is laterally aligned with the first weakened portion and at least a portion of the second loading member is laterally aligned with the second weakened portion.

6. The seat assembly of claim 4, wherein the first loading member is laterally offset from the first weakened portion and the second loading member is laterally offset from the second weakened portion.

7. The seat assembly of claim 1, wherein the weakened portion comprises a first weakened portion and a second weakened portion, wherein the first weakened portion extends vertically through a thickness of the seat pan and the second weakened portion extends vertically partially through the thickness of the seat pan.

8. The seat assembly of claim 7, wherein the first weakened portion extends forwardly to a termination point and the second weakened portion extends forwardly from the termination point.

9. The seat assembly of claim 1, wherein the seat pan includes a generally concave upper surface.

10. The seat assembly of claim 1, further comprising a seat restraint, and a portion of the seat restraint is laterally aligned with the weakened portion.

11. The seat assembly of claim 10, wherein the weakened portion is a first weakened portion and the seat restraint includes a first component and a second component, and the seat pan further comprises a second weakened portion laterally offset from the first weakened portion, and at least a portion of the first component is laterally aligned with the first weakened portion and at least a portion of the second component is laterally aligned with the second weakened portion.

12. The seat assembly of claim 1, wherein the seat assembly is coupled to an aircraft.

13. A seat assembly, comprising:
a base assembly;
a seat pan supported by the base assembly;
a plurality of loading members positioned below the seat pan;
the seat pan, comprising:
a first portion movable about a laterally extending axis;
a second portion coupled to, and laterally offset from, the first portion, the second portion movable about the laterally extending axis semi-independent of the first portion;
a first loading member of the plurality of loading members supporting the first portion; and
a second loading member of the plurality of loading members supporting the second portion.

14. The seat assembly of claim 13, further comprising a third portion positioned intermediate the first portion and the second portion, the third portion movable about the laterally extending axis semi-independent of each of the first portion and the second portion.

15. The seat assembly of claim 14, further comprising a first weakened portion extending longitudinally along the seat pan and separating the first portion and the third portion and a second weakened portion extending longitudinally along the seat pan and separating the second portion and the third portion.

16. The seat assembly of claim 14, further comprising a third loading member of the plurality of loading members supporting the third portion.

17. The seat assembly of claim 13, wherein the first loading member is configured to support each of the first portion and the second portion.

18. The seat assembly of claim 13, wherein the seat assembly is coupled to an aircraft.

19. A method of manufacturing a seat assembly comprising a seat pan, a first loading member, and a second loading member, the method comprising:
applying a first weakened portion into the seat pan, the first weakened portion separating the seat pan into a first portion and a second portion;
positioning a first loading member vertically below the first portion to support the first portion; and
positioning a second loading member vertically below the second portion to support the second portion semi-independently of the first portion.

20. The method of claim 19, further comprising:
applying a second weakened portion to the seat pan, the second weakened portion positioned laterally offset from the first weakened portion, and the first weakened portion separating the first portion from a third portion and the second weakened portion separating the second portion from the third portion.

21. The method of claim 19, wherein the positioning the first loading member vertically below the first portion to support the first portion includes positioning the first loading member vertically below a portion of each of the first portion and the second portion to support each of the first portion and the second portion.

22. The method of claim 19, wherein the applying the first weakened portion to the seat pan comprises creating a through-cut extending longitudinally forwardly from a rearward extent of the seat pan.

23. The method of claim 22, wherein the through-cut defines at least 25% of the length of the seat pan.

24. The method of claim 19, providing an aircraft comprising a cabin floor, the method further comprising:
coupling the seat assembly to the cabin floor of the aircraft.

25. A seat assembly, comprising:
a vertically extending frame member;
a first frame member coupled to the vertically extending frame member and extending generally rearwardly;
a second frame member operably coupled to the first frame member, the second frame member positioned rearwardly of the vertically extending frame member;
a third frame member coupled to each of the vertically extending frame member and the second frame member, the third frame member positioned generally vertically above the first frame member; and
a seat pan coupled to the vertically extending member, the seat pan generally cantilevered rearwardly.

26. The seat assembly of claim 25, further comprising a plate member coupled between the first frame member and the second frame member, and a loading member coupled to the plate member.

27. The seat assembly of claim 26, wherein the loading member generally extends between the plate member and the seat pan.

28. The seat assembly of claim 25, wherein the seat pan defines a body portion including a recess, the recess laterally aligned with the first frame member.

29. The seat assembly of claim 28, wherein the seat pan is operable to rotate about an axis between a first position and a second position, and in the first position the third frame member is configured to sit outside the recess and in the second position the third frame member is configured to sit within the recess.
